(19) United States
(12) Patent Application Publication
(10) Pub. No.: US 2012/0249480 A1
(43) Pub. Date: Oct. 4, 2012

(54) INTERACTIVE INPUT SYSTEM INCORPORATING MULTI-ANGLE REFLECTING STRUCTURE

(75) Inventors: Vaughn Keenan, Calgary (CA); Alex Chtchetinine, Calgary (CA)

(73) Assignee: SMART TECHNOLOGIES ULC, Calgary (CA)

(21) Appl. No.: 13/432,589

(22) Filed: Mar. 28, 2012

Related U.S. Application Data
(60) Provisional application No. 61/470,475, filed on Mar. 31, 2011.

(51) Int. Cl. G06F 3/042

(52) U.S. Cl. 345/175

(57) ABSTRACT

An interactive input system includes at least one image sensor capturing image frames of a region of interest; at least one light source emitting illumination into the region of interest; a bezel at least partially surrounding the region of interest, the bezel comprising at least one multi-angle reflector reflecting the illumination emitted from the light source towards the at least one image sensor; and processing structure in communication with the at least one image sensor processing captured image frames for locating a pointer positioned in proximity with the regin of interest. A method of generating image frames is also provided.

### FIELD OF THE INVENTION

The present invention relates generally to interactive input systems and in particular, to an interactive input system incorporating a multi-angle reflecting structure.

### BACKGROUND OF THE INVENTION

Interactive input systems that allow users to inject input (e.g. digital ink, mouse events etc.) into an application program using an active pointer (e.g. a pointer that emits light, sound or other signal), a passive pointer (e.g. a finger, cylinder or other suitable object) or other suitable input device such as for example, a mouse or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the entire contents of which are incorporated herein by reference in their entirety; touch systems comprising touch panels employing electromagnetic, capacitive, acoustic or other technologies to register pointer input; tablet and laptop personal computers (PCs); personal digital assistants (PDAs) and other handheld devices; and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital cameras at its corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

To enhance the ability to detect and recognize passive pointers brought into proximity of a touch surface in touch systems employing machine vision technology, it is known to employ illuminated bezels to illuminate evenly the region over the touch surface. For example, U.S. Pat. No. 6,972,401 to Akitt et al. issued on Dec. 6, 2005 and assigned to SMART Technologies ULC, discloses an illuminated bezel for use in a touch system such as that described in above-incorporated U.S. Pat. No. 6,803,906. The illuminated bezel emits infrared or other suitable radiation over the touch surface that is visible to the digital cameras. As a result, in the absence of a passive pointer in the fields of view of the digital cameras, the illuminated bezel appears in captured images as a continuous bright or “white” band. When a passive pointer is brought into the fields of view of the digital cameras, the pointer occludes emitted radiation and appears as a dark region interrupting the bright or “white” band in captured images allowing the existence of the pointer in the captured images to be readily determined and its position triangulated. Although this illuminated bezel is effective, it is expensive to manufacture and can add significant cost to the overall touch system. It is therefore not surprising that alternative techniques to illuminate the region over touch surfaces have been considered.

For example, U.S. Pat. No. 7,283,128 to Sato discloses a coordinate input apparatus including a light-receiving unit arranged in a coordinate input region, a retroreflecting unit arranged at the peripheral portion of the coordinate input region to reflect incident light and a light-emitting unit which illuminates the coordinate input region with light. The retroreflecting unit is a flat tape and includes a plurality of triangular prisms each having an angle determined to be equal to or less than the detection resolution of the light-receiving unit. Angle information corresponding to a point which crosses a predetermined level in a light amount distribution obtained from the light receiving unit is calculated. The coordinates of the pointer position are calculated on the basis of a plurality of pieces of calculated angle information, the angle information corresponding to light emitted by the light-emitting unit that is reflected by the pointer.

While the Sato retroreflecting unit may be less costly to manufacture than an illuminated bezel, problems with retroreflecting units exist. For example, the amount of light reflected by the retroreflecting unit is dependent on the incident angle of the light. As a result, the retroreflecting unit will generally perform better when the incident light is normal to the retroreflecting surface. However, when the angle of the incident light deviates from normal, the illumination provided to the coordinate input region may become reduced. In this situation, the possibility of false pointer contacts and/or missed pointer contacts may increase. Improvements are therefore desired.

It is therefore an object of the present invention to provide a novel interactive input system incorporating a multi-angle reflecting structure.

### SUMMARY OF THE INVENTION

Accordingly, in one aspect there is provided an interactive input system comprising at least one image sensor capturing image frames of a region of interest; at least one light source emitting illumination into the region of interest; a bezel at least partially surrounding the region of interest, the bezel comprising at least one multi-angle reflector reflecting the illumination emitted from the light source towards the at least one image sensor; and processing structure in communication with the at least one image sensor processing captured image frames for locating a pointer positioned in proximity with the region of interest.

In one embodiment, the multi-angle reflector comprises at least one series of mirror elements extending along the bezel, the mirror elements being configured to reflect the illumination emitted from the at least one light source towards the at least one image sensor. In another embodiment, each mirror element is sized to be smaller than the pixel resolution of the at least one image sensor. In still another embodiment, each mirror element presents a reflective surface that is angled to reflect the illumination emitted from the at least one light source towards the at least one image sensor. In still yet another embodiment, the configuration of the reflective surfaces varies over the length of the bezel.

In another embodiment, the processing structure processing captured image frames further calculates an approximate size and shape of the pointer within the region of interest.

In still another embodiment, the system further comprises at least two image sensors, the image sensors looking into the region of interest from different vantages and having overlapping fields of view, each bezel segment seen by an image sensor comprising a multi-angle reflector to reflect illumination emitted from the at least one light source towards that image sensor.

In still yet another embodiment, the multi-angle reflector comprises at least one series of mirror elements extending along a bezel not within view of the at least one image sensor, the mirror elements being configured to reflect illumination emitted from the at least one light source towards another multi-angle reflector extending along an opposite bezel from which the illumination is reflected towards the at least one image sensor.

In another aspect, there is provided an interactive input system comprising at least one image sensor capturing image frames of a region of interest; a plurality of light sources emitting illumination into the region of interest; a bezel at least partially surrounding the region of interest, the bezel comprising a multi-angle reflector to reflect illumination emitted from the plurality of light sources towards the image sensor; and processing structure in communication with the image sensor processing captured image frames for locating a pointer positioned in proximity with the region of interest.

In still another aspect, there is provided an interactive input system comprising a plurality of image sensors each capturing image frames of a region of interest; a light source emitting illumination into the region of interest; a bezel at least partially surrounding the region of interest, the bezel comprising a multi-angle reflector to reflect illumination emitted from the light source towards the plurality of image sensors; and processing structure in communication with the image sensors processing captured image frames for locating a pointer positioned in proximity with the region of interest.

In still yet another aspect, there is provided an interactive input system comprising a bezel at least partially surrounding a region of interest, the bezel having a plurality of films thereon with adjacent films having different reflective structures; at least one image sensor looking into the region of interest and seeing the at least one bezel so that acquired image frames comprise regions corresponding to the films; and processing structure processing pixels of a plurality of the regions to detect the existence of a pointer in the region of interest.

In one embodiment, the processing structure processes the pixels to detect discontinuities in the regions caused by the existence of the pointer. In another embodiment, the films are generally horizontal. In still another embodiment, the films comprise at least one film that reflects illumination from a first source of illumination towards at least one of the image sensors, and least another film that reflects illumination from a second source of illumination towards the image sensor.

In still another aspect, there is provided an interactive input system comprising at least two image sensors capturing images of a region of interest; at least two light sources to provide illumination into the region of interest; a controller timing the frame rates of the image sensors with distinct switching patterns assigned to the light sources; and processing structure processing the separated image frames to determine the location of a pointer within the region of interest.

In one embodiment, each light source is switched on and off according to a distinct switching pattern. In another embodiment, the distinct switching patterns are substantially sequential.

In still yet another aspect, there is provided a method of generating image frames in an interactive input system comprising at least one image sensor capturing images of a region of interest and multiple light sources providing illumination into the region of interest, the method comprising turning each light source on and off according to a distinct sequence; synchronizing the frame rate of the image sensor with the distinct sequence; and processing the captured image frames to yield image frames based on contributions from different light sources.

### BRIEF DESCRIPTION OF THE DRAWINGS

Embodiments will now be described more fully with reference to the accompanying drawings in which:

FIG. 1 is a schematic view of an interactive input system;

FIG. 2 is a block diagram of an imaging assembly forming part of the interactive input system of FIG. 1;

FIG. 3 is a block diagram of a master controller forming part of the interactive input system of FIG. 1;

FIGS. 4a and 4b are schematic and geometric views, respectively, of an assembly forming part of the interactive input system of FIG. 1, showing interaction of a pointer with light emitted by the assembly;

FIG. 5 is a sectional side view of a portion of a bezel forming part of the assembly of FIG. 4;

FIG. 6 is a front view of a portion of the bezel of FIG. 5, as seen by an imaging assembly during the pointer interaction of FIG. 4;

FIG. 7 is a front view of another embodiment of an assembly forming part of the interactive input system of FIG. 1, showing the fields of view of imaging assemblies;

FIGS. 8a and 8b are schematic views of the assembly of FIG. 7, showing interaction of a pointer with light emitted by the assembly;

FIG. 9 is perspective view of a portion of a bezel forming part of the assembly of FIG. 7;

FIGS. 10a and 10b are front views of a portion of the bezel of FIG. 9, as seen by each of the imaging assemblies during the pointer interactions of FIGS. 8a and 8b, respectively;

FIG. 11 is a front view of another embodiment of an assembly forming part of the interactive input system of FIG. 1;

FIG. 12 is a schematic view of a portion of a bezel forming part of the assembly of FIG. 11;

FIG. 13 is a schematic view of the assembly of FIG. 11, showing interaction of pointers with the assembly;

FIGS. 14a to 14e are schematic views of the assembly of FIG. 11, showing interaction of pointers of FIG. 13 with light emitted by the assembly;

FIGS. 15a to 15e are front views of a portion of a bezel forming part of the assembly of FIG. 11, as seen by an imaging assembly forming part of the assembly during the pointer interaction shown in FIGS. 14a to 14e, respectively;

FIG. 16 is a schematic view of the assembly of FIG. 11, showing pointer location areas calculated for the pointer interaction shown in FIGS. 14a to 14e;

FIG. 17 is a front view of still another embodiment of an assembly forming part of the interactive input system of FIG. 1;

FIG. 18 is a front view of still yet another embodiment of an assembly forming part of the interactive input system of FIG. 1;

FIG. 19 is a front view of still another embodiment of an assembly forming part of the interactive input system of FIG. 1;

FIG. 20 is a front view of still yet another embodiment of an assembly forming part of the interactive input system of FIG. 1;

FIG. 21 is a schematic view of the assembly of FIG. 20, showing paths taken by light emitted by the assembly during use;

FIG. 22 is a schematic view of the assembly of FIG. 20, showing interaction of a pointer with light emitted by the assembly during use;

FIG. 23 is a front view of a portion of a bezel, as seen by an imaging assembly forming part of the assembly during the pointer interaction of FIG. 22;

FIG. 24 is a graphical plot of a vertical intensity profile of the bezel portion of FIG. 23;

FIGS. 25a to 25c are schematic views of still another embodiment of an assembly forming part of the interactive input system of FIG. 1, showing interaction of a pointer with light emitted by the assembly during use;

FIGS. 26a to 26c are front views of a portion of the bezel forming part of the assembly of FIGS. 25a to 25c, as seen by the imaging assembly during the pointer interaction of FIGS. 25a to 25c.

### DETAILED DESCRIPTION OF THE PREFERRED EMBODIMENTS

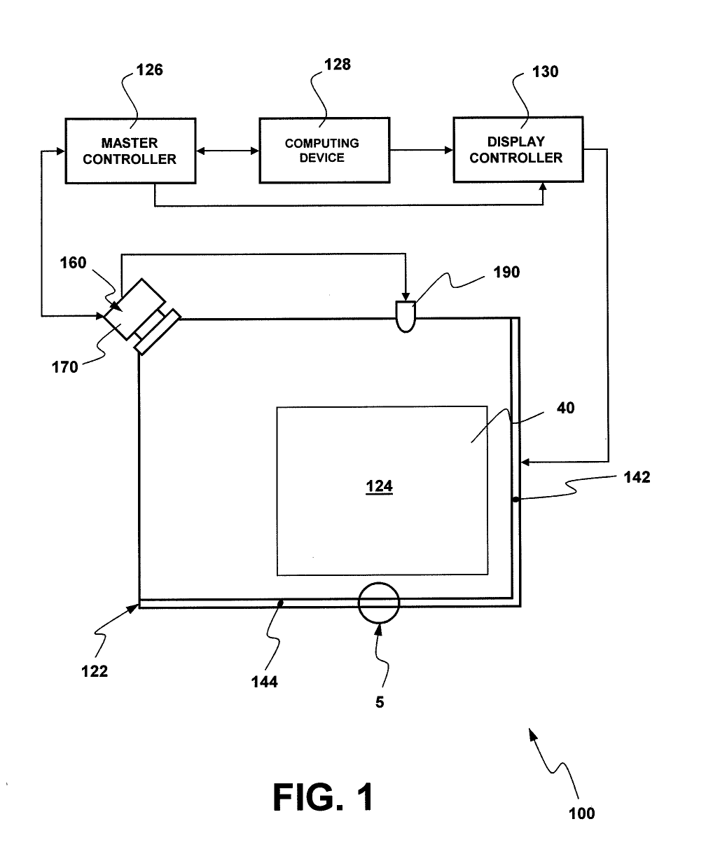

Turning now to FIG. 1, an interactive input system that allows a user to inject input such as digital ink, mouse events etc. into an application program is shown and is generally identified by reference numeral 100. In this embodiment, interactive input system 100 comprises an assembly 122 that engages a display unit (not shown) such as for example, a plasma television, a liquid crystal display (LCD) device, a flat panel display device, a cathode ray tube etc. and surrounds the display surface 124 of the display unit. The assembly 122 employs machine vision to detect pointers brought into proximity with the display surface 124 and communicates with a master controller 126. The master controller 126 in turn communicates with a general purpose computing device 128 executing one or more application programs. General purpose computing device 128 processes the output of the assembly 122 and provides display output to a display controller 130. Display controller 130 controls the image data that is fed to the display unit so that the image presented on the display surface 124 reflects pointer activity. In this manner, the assembly 122, master controller 126, general purpose computing device 128 and display controller 130 allow pointer activity proximate to the display surface 124 to be recorded as writing or drawing or used to the control execution of one or more application programs executed by the general purpose computing device 128.

Assembly 122 comprises a frame assembly that is mechanically attached to the display unit and surrounds the display surface 124 having an associated region of interest 40. As may be seen, the periphery of the assembly 122 defines an area that is greater in size than the region of interest 40. Assembly 122 comprises a bezel which, in this embodiment, has two bezel segments 142 and 144. Bezel segment 142 extends along a right side of display surface 124, while bezel segment 144 extends along a bottom side of the display surface 124. The bezel segments 142 and 144 are oriented so that their inwardly facing surfaces are generally normal to the plane of the display surface 124. In this embodiment, assembly 122 also comprises an imaging assembly 160 that comprises an image sensor 170 positioned adjacent the upper left corner of the assembly 122. Image sensor 170 is oriented so that its field of view looks generally across the entire display surface 124 towards bezel segments 142 and 144. As will be appreciated, the assembly 122 is sized relative to the region of interest 40 so as to enable the image sensor 170 to be positioned such that all or nearly all illumination emitted by IR light source 190 traversing the region of interest 40 is reflected by bezel segments 142 and 144 towards image sensor 170.

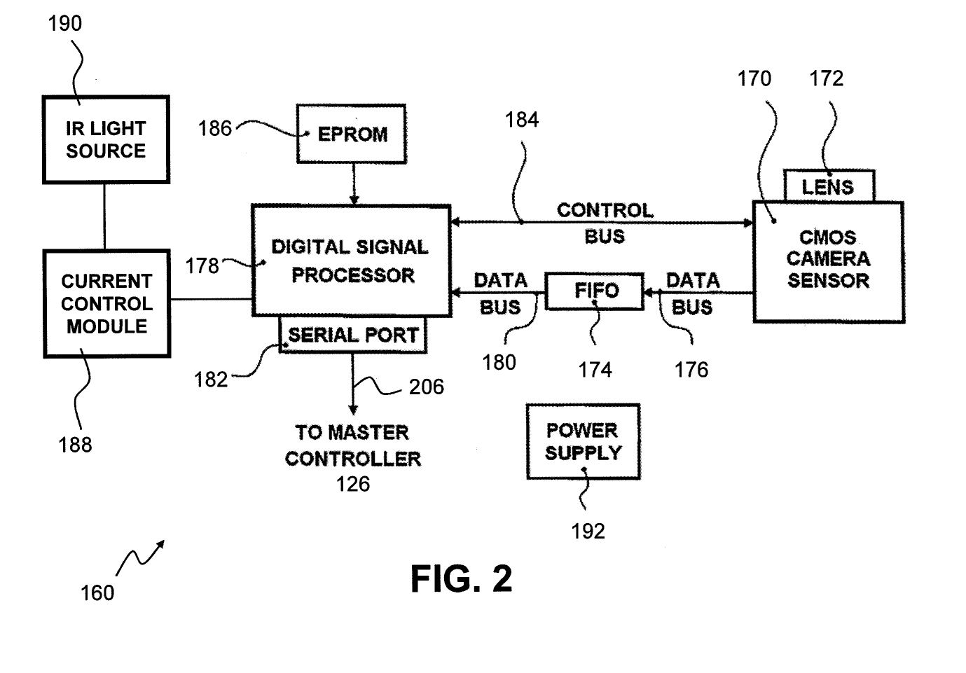

Turning now to FIG. 2, imaging assembly 160 is better illustrated. As can be seen, the imaging assembly comprises an image sensor 170 such as that manufactured by Micron Technology, Inc. of Boise, Id. under model No. MT9V022 fitted with an 880 nm lens 172 of the type manufactured by Boowon Optical Co. Ltd. under model No. BW25B. The lens 172 provides the image sensor 170 with a 98 degree field of view so that the entire display surface 124 is seen by the image sensor. The image sensor 170 communicates with and outputs image frame data to a first-in first-out (FIFO) buffer 174 via a data bus 176. A digital signal processor (DSP) 178 receives the image frame data from the FIFO buffer 174 via a second data bus 180 and provides pointer data to the master controller 126 via a serial input/output port 182 when a pointer exists in image frames captured by the image sensor 170. The image sensor 170 and DSP 178 also communicate over a bi-directional control bus 184. An electronically programmable read only memory (EPROM) 186 which stores image sensor calibration parameters is connected to the DSP 178. A current control module 188 is also connected to the DSP 178 as well as to an infrared (IR) light source 190 comprising one or more IR light emitting diodes (LEDs). The configuration of the LEDs of the IR light source 190 is selected to generally evenly illuminate the bezel segments in field of view of the image sensor. The imaging assembly components receive power from a power supply 192.

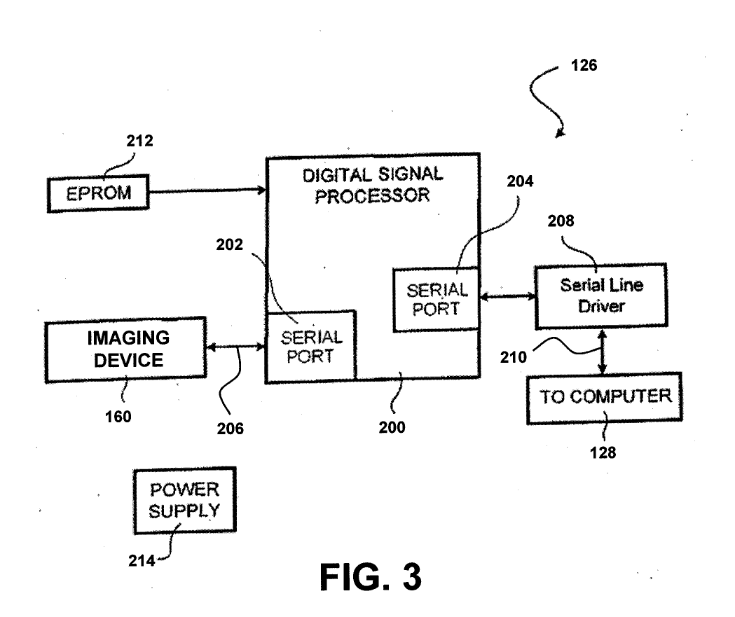

FIG. 3 better illustrates the master controller 126. Master controller 126 comprises a DSP 200 having a first serial input/output port 202 and a second serial input/output port 204. The master controller 126 communicates with imaging assembly 160 via first serial input/output port 20 over communication lines 206. Pointer data received by the DSP 200 from imaging assembly 160 is processed by DSP 200 to generate pointer location data as will be described. DSP 200 communicates with the general purpose computing device 128 via the second serial input/output port 204 and a serial line driver 208 over communication lines 210. Master controller 126 further comprises an EPROM 212 that stores interactive input system parameters. The master controller components receive power from a power supply 214.

The general purpose computing device 128 in this embodiment is a computer comprising, for example, a processing unit, system memory (volatile and/or non-volatile memory), other non-removable or removable memory (e.g. a hard disk drive, RAM, ROM, EEPROM, CD-ROM, DVD, flash memory, etc.) and a system bus coupling the various computer components to the processing unit. The computer can include a network connection to access shared or remote drives, one or more networked computers, or other networked devices.

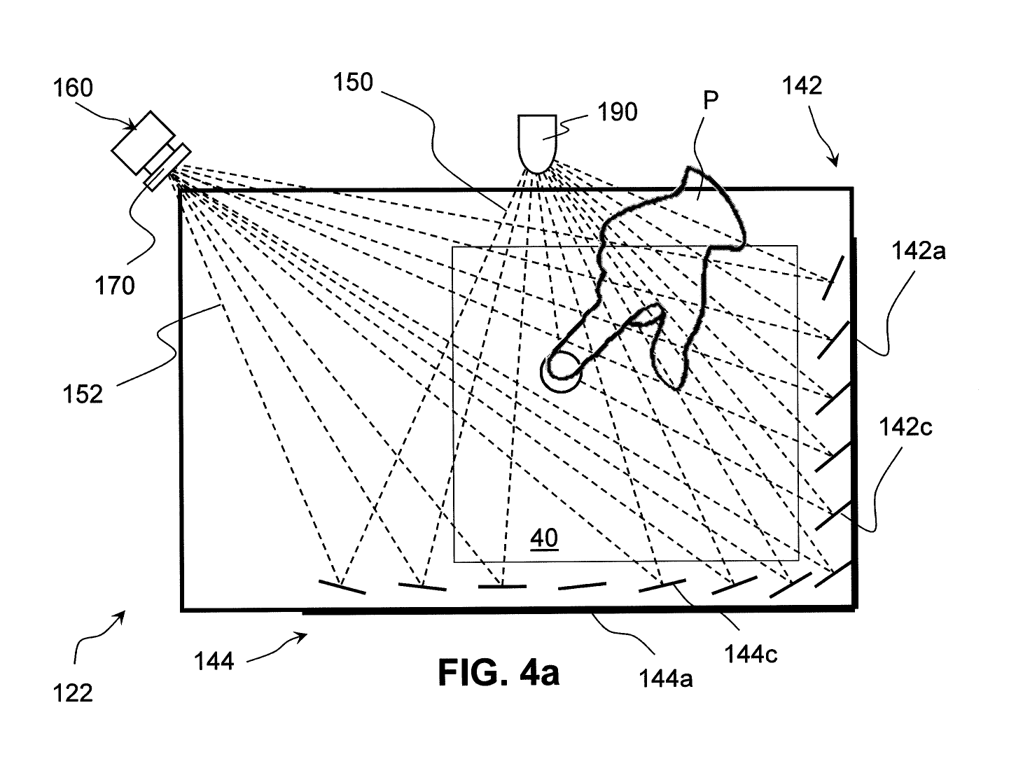

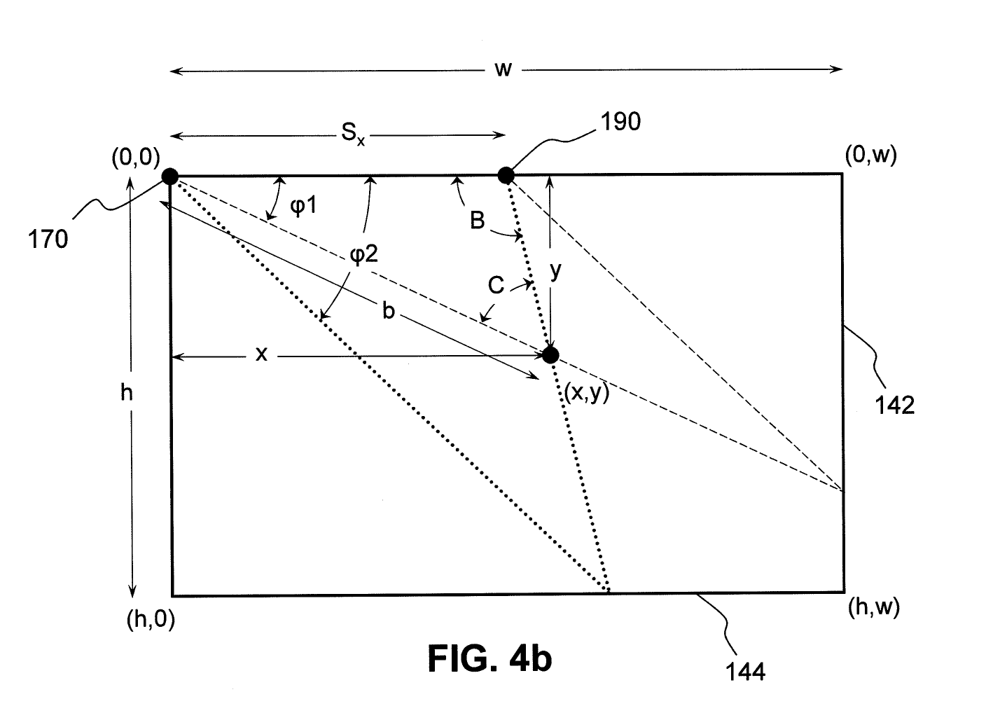

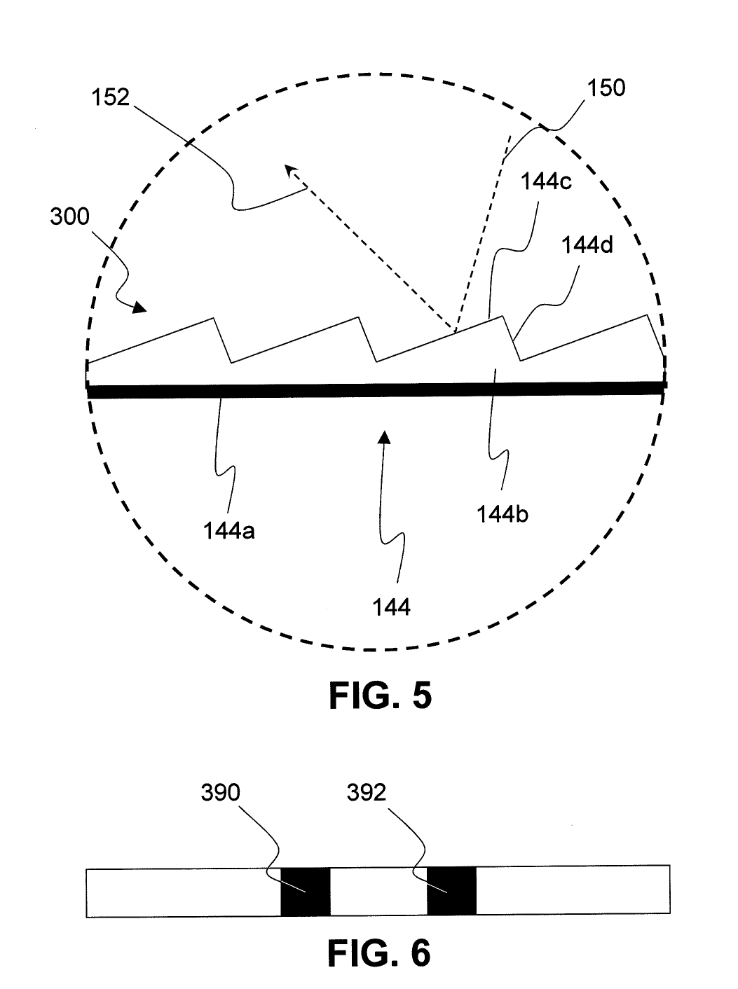

Turning now to FIGS. 4a, 4b and 5, the structure of the bezel segments is illustrated in more detail. In this embodiment, bezel segments 142 and 144 each comprise a backing 142a and 144a, respectively, that is generally normal to the plane of the display surface 124. Backings 142a and 144a each have an inwardly directed surface on which a respective plastic film 142b (not shown) and 144b is disposed. Each of the plastic films 142b and 144b is machined and engraved so as to form a faceted multi-angle reflector 300. The facets of the multi-angle reflector 300 define a series of highly reflective, generally planar mirror elements 142c and 144c, respectively, extending the length of the plastic films. The mirror elements are configured to reflect illumination emitted by the IR light source 190 towards the image sensor 170, as indicated by dotted lines 152. In this embodiment, the angle of consecutive mirror elements 142c and 144c is varied incrementally along the length of each of the bezel segments 142 and 144, respectively, as shown in FIG. 4a, so as to increase the amount of illumination that is reflected to the image sensor 170.

Mirror elements 142c and 144c are sized so that they are generally smaller than the pixel resolution of the image sensor 170. In this embodiment, the widths of the mirror elements 142c and 144c are in the sub-micrometer range. In this manner, the mirror elements 142c and 144c do not reflect discrete images of the IR light source 190 to the image sensor 170. As micromachining of optical components on plastic films is a well-established technology, the mirror elements 142c and 144c on plastic films 142b and 144b can be formed with a high degree of accuracy at a reasonably low cost.

The multi-angle reflector 300 also comprises side facets 142d (not shown) and 144d situated between mirror elements 142c and 142d. Side facets 142d and 144d are oriented such that faces of facets 142d and 144d are not seen by image sensor 170. This orientation reduces the amount of stray and ambient light that would otherwise be reflected from the side facets 142d and 144d to the image sensor 170. In this embodiment, side facets 142d and 144d are also coated with a non-reflective paint.

During operation, the DSP 178 of imaging assembly 160 generates clock signals so that the image sensor 170 captures image frames at a desired frame rate. The DSP 178 also signals the current control module 188 of imaging assembly 160. In response, the current control module 188 connects its associated IR light source 190 to the power supply 192. When the IR light source 190 is on, each LED of the IR light source 190 floods the region of interest over the display surface 124 with infrared illumination. Infrared illumination emitted by IR light source 190 that impinges on the mirror elements 142c and 144c of the bezel segments 142 and 144, respectively, is reflected toward the image sensor 170 of the imaging assembly 160. As a result, in the absence of any pointer within the field of view of the image sensor 170, the bezel segments 142 and 144 appear as a bright “white” band having a substantially even intensity over its length in image frames captured by the imaging assembly 160.

When a pointer is brought into proximity with the display surface 124, the pointer occludes infrared illumination and as a result, two dark regions 390 and 392 corresponding to the pointer and interrupting the bright band appear in image frames captured by the imaging assembly 160, as illustrated in FIG. 6. Here, dark region 390 is caused by occlusion by the pointer of infrared illumination that has reflected from bezel segment 142, indicated by dotted lines 152. Dark region 392 is caused by occlusion by the pointer of infrared illumination emitted by the IR light source 190, indicated by dotted lines 150, which in turn casts a shadow on bezel segment 144.

Each image frame output by the image sensor 170 of imaging assembly 160 is conveyed to the DSP 178. When the DSP 178 receives an image frame, the DSP 178 processes the image frame to detect the existence of a pointer therein and if a pointer exists, generates pointer data that identifies the position of the pointer and occluded reflection within the image frame.

If a pointer is determined to exist in an image frame, the image frame is further processed to determine characteristics of the pointer, such as whether the pointer is contacting or hovering above the display surface 124. These characteristics are then converted into pointer information packets (PIPs) by the DSP 178, and the PIPS are queued for transmission to the master controller 126. Here, the PIP is a five (5) word packet comprising a layout including an image sensor identifier, a longitudinal redundancy check (LRC) checksum to ensure data integrity, and a valid tag so as to establish that zero packets are not valid.

As mentioned above, imaging assembly 160 acquires and processes an image frame in the manner described above in response to each clock signal generated by its DSP 200. The PIPs created by the DSP 200 are sent to the master controller 126 via serial port 182 and communication lines 206 only when the imaging assembly 160 is polled by the master controller. As the DSP 200 creates PIPs more quickly than the master controller 126 polls imaging assembly 160, PIPs that are not sent to the master controller 126 are overwritten.

When the master controller 126 polls the imaging assembly 160, frame sync pulses are sent to imaging assembly 160 to initiate transmission of the PIPs created by the DSP 200. Upon receipt of a frame sync pulse, DSP 200 transmits a PIP to the master controller 126. The PIPs transmitted to the master controller 126 are received via the serial port 182 and are automatically buffered into the DSP 200.

After the DSP 200 has polled and received a PIP from the imaging assembly 160, the DSP 200 processes the PIP using triangulation to determine the location of the pointer relative to the display surface 124 in (x,y) coordinates.

Two angles φ1 and φ2 are needed to triangulate the position (x0,y0) of the pointer relative to the display surface 124. These two angles are illustrated in FIG. 4b. The PIPs generated by imaging assembly 160 include a numerical value θε[0, sensorResolution−1] identifying the median line of the pointer, where sensorResolution corresponds to a numerical value of the resolution of the image sensor. For the case of the Micron Technology MT9V022 image sensor, for example, the value of sensorResolution is 750.

Taking into account the field-of-view (Fov) of the image sensor 170 and lens 172, angle φ is related to a position θ by:

φ=(θ/sensorResolution)*Fov−δ (1)

φ=((SensorResolution−θ)/sensorResolution)*Fov−δ (2)

As will be understood, Equations (1) and (2) subtract away an angle δ that allows the image sensor 170 and lens 172 to partially overlap with the frame. Overlap with the frame is generally desired in order to accommodate manufacturing tolerances of the assembly 122. For example, the angle of mounting plates that secure the imaging assembly 160 to assembly 122 may vary by 1° or 2° due to manufacturing issues. Equation 1 or 2 may be used to determine φ, depending on the mounting and/or optical configuration of the image sensor 170 and lens assembly 172. In this embodiment, Equation 1 is used to determine cp.

As discussed above, equations 1 and 2 allow the pointer median line data included in the PIPs to be converted by the DSP 200 into an angle φ with respect to the x-axis. When two such angles are available, the intersection of median lines extending at these angles yields the location of the pointer relative to the region of interest 40.

To determine a pointer position using the PIPs received from the imaging assembly 160 positioned adjacent the top left corner of the input system 100, the following equations are used to determine the (x0, y0) coordinates of the pointer position given the angles φ1 and φ2:

y0=B*sin(φ1) (3)

x0=SQRT(b²−y²) (4)

where B is the angle formed by a light source, image sensor and the touch location of pointer, as shown in FIG. 4b, with the light source being the vertex and described by the equation:

B=arctan(h/(Sx−h/tan φ2)); (5)

C is the angle formed by a light source, image sensor and the touch location of pointer, with the pointer being the vertex and described by the equation:

C=180−(B+φ1) (6)

and h is the vertical distance from camera assembly focal point to the opposing horizontal bezel, φ1 is the angle of the pointer with respect to the horizontal, measured from the horizontal, using the imaging assembly and equation 1 or 2, φ2 is the angle of the pointer shadow with respect to the horizontal, measured from the horizontal, using the imaging assembly and equation 1 or 2, Sx is the horizontal distance from the imaging assembly focal point to a focal point of the IR light source 190; and b is the distance between the focal point of the image sensor 170 and the location of the pointer, as described by the equation:

b=Sx(sin B/sin C). (7)

The calculated pointer position is then conveyed by the master controller 126 to the general purpose computing device 128. The general purpose computing device 128 in turn processes the received pointer position and updates the image output provided to the display controller 130, if required, so that the image presented on the display surface 124 can be updated to reflect the pointer activity. In this manner, pointer interaction with the display surface 124 can be recorded as writing or drawing or used to control execution of one or more application programs running on the general purpose computing device 128.

Although in the embodiment described above, Equation 1 is used to to determine φ in other embodiments, Equation 2 may alternatively be used. For example, in other embodiments in which captured image frames are rotated as a result of the location, the mounting configuration, and/or the optical properties of the image sensor 170, Equation 2 may be used. For example, if the image sensor 170 is alternatively positioned at the top right corner or the bottom left corner of the region of interest 40, then Equation 2 is used.

In the embodiment described above, the assembly 22 comprises a single image sensor and a single IR light source. However, in other embodiments, the assembly may alternatively comprise more than one image sensor and more than one IR light source. In these embodiments, the master controller 126 calculates pointer position using triangulation for each image sensor/light source combination. Here, the resulting pointer positions are then averaged and the resulting pointer position coordinates are queued for transmission to the general purpose computing device.

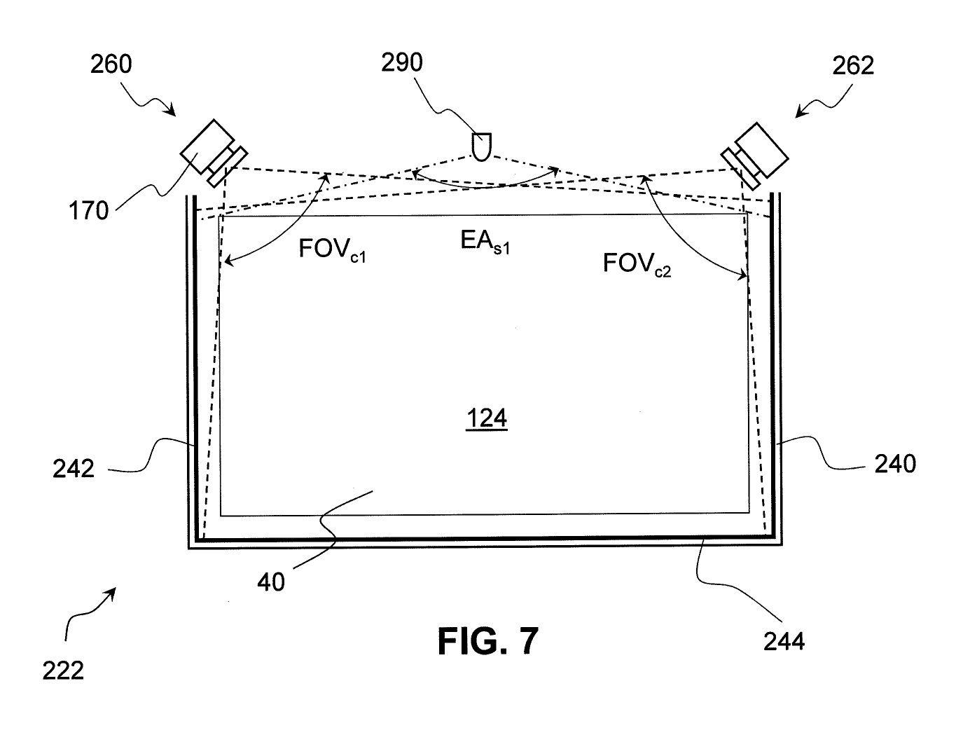

FIG. 7 shows another embodiment of an assembly for use with the interactive input system 100, and which is generally indicated by reference numeral 222. Assembly 222 is generally similar to assembly 122 described above and with reference to FIGS. 1 to 6, however assembly 222 comprises three (3) bezel segments 240, 242 and 244. Here, bezel segments 240 and 242 extend along right and left sides of the display surface 124, respectively, while bezel segment 244 extends along the bottom side of the display surface 124. Assembly 222 also comprises two (2) imaging assemblies 260 and 262. In this embodiment, imaging assembly 260 comprises an image sensor 170 and an IR light source 290, while imaging assembly 262 comprises an image sensor 170. The image sensors 170 of the imaging assemblies 260 and 262 are positioned proximate the upper left and upper right corners of the assembly 222, respectively, and have overlapping fields of view FOV_{c1} and FOV_{c2}, respectively. Image sensors 170 look generally across the display surface 124 towards bezel segments 240, 242 and 244. The overlapping fields of view result in all of bezel segment 244 being seen by both image sensors 170. Additionally, at least a portion of each of bezel segments 240 and 242 are seen by the image sensors 170 of imaging assemblies 260 and 262, respectively. IR light source 290 is positioned between the image sensors 170 of imaging assemblies 260 and 262. IR light source 290 has an emission angle EA_{S1} over which it emits light generally across the display surface 124 and towards the bezel segments 240, 242 and 244. As may be seen, IR light source 290 is configured to illuminate all of bezel segment 244 and at least a portion of each of bezel segments 240 and 242.

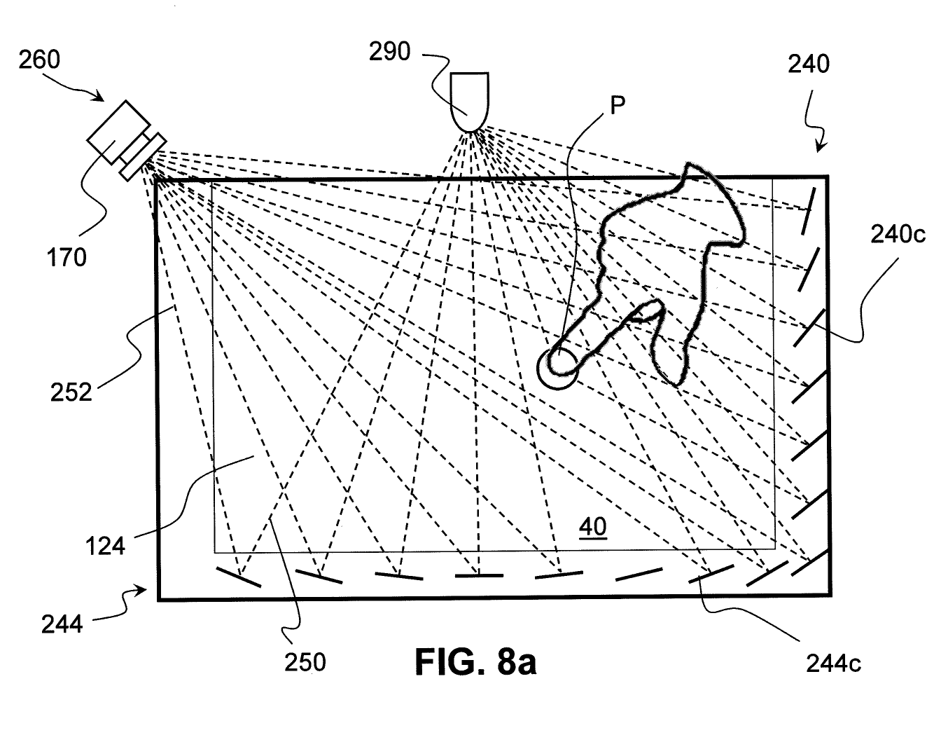

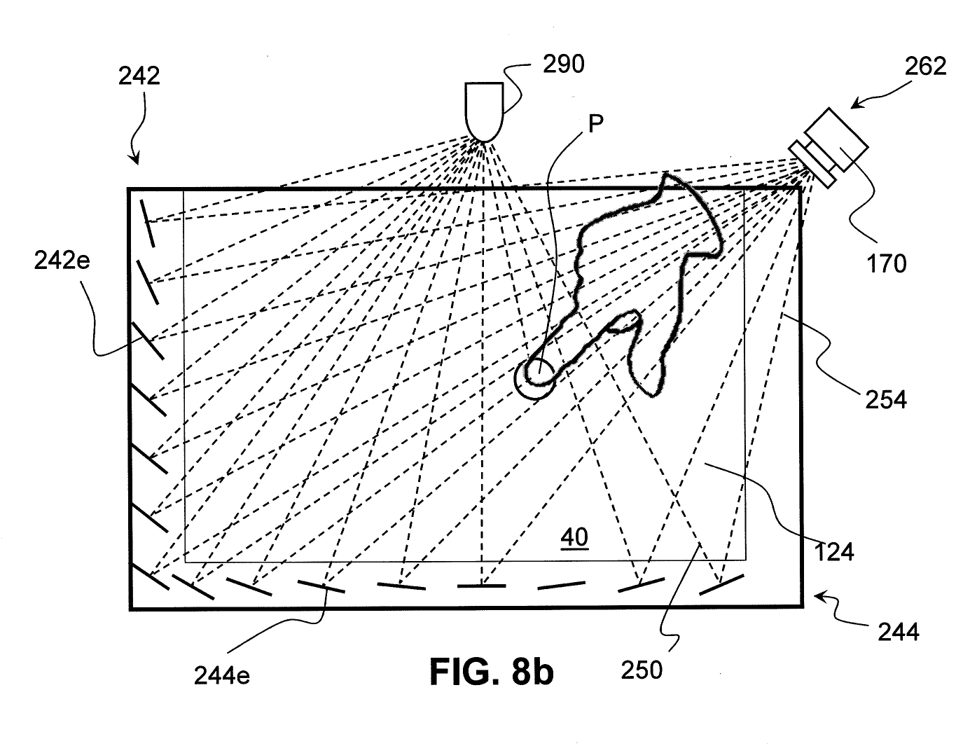

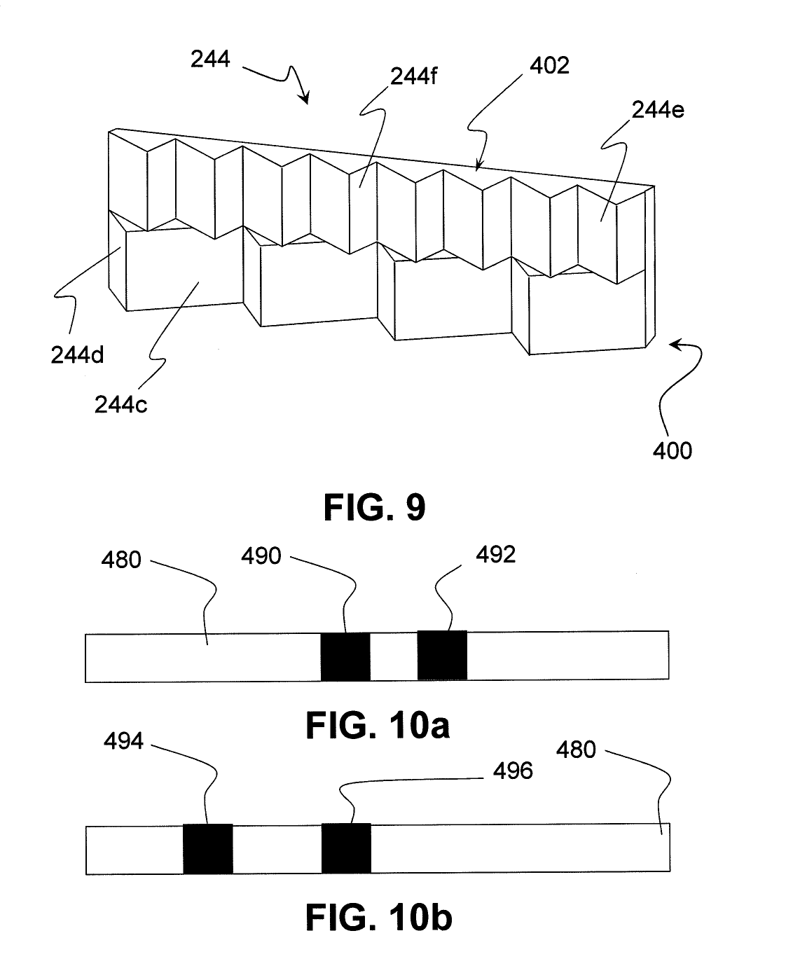

The structure of bezel segments 240, 242 and 244 is provided in additional detail in FIGS. 8a, 8b and 9. Each of the bezel segments 240, 242 and 244 comprises at least one plastic film (not shown) that is machined and engraved so as to form faceted multi-angle reflectors. Here, the plastic film of bezel segment 240 and a first plastic film of bezel segment 244 are machined and engraved to form a multi-angle reflector 400. The facets of the multi-angle reflector 400 define a series of highly reflective, generally planar mirror elements 240c and 244c, respectively, extending the length of the plastic films. The mirror elements 240c and 244c are configured to reflect illumination emitted by IR light source 290 to image sensor 170 of imaging assembly 260, as indicated by dotted lines 252 in FIG. 8a. In this embodiment, the angle of consecutive mirror elements 240c and 244c is varied incrementally along the length of bezel segments 240 and 244, as shown in FIG. 8a, so as to increase the amount of illumination that is reflected to imaging assembly 260.

The plastic film of bezel segment 242 and a second plastic film of bezel segment 244 are machined and engraved to define a second faceted multi-angle reflector 402. The facets of the multi-angle reflector 402 define a series of highly reflective, generally planar mirror elements 242e and 244e, respectively, extending the length of the plastic films. The mirror elements 242e and 244e are configured to reflect illumination emitted by IR light source 290 to image sensor 170 of imaging assembly 262, as indicated by dotted lines 254 in FIG. 8b. In this embodiment, the angle of consecutive mirror elements 242e and 244e is varied incrementally along the bezel segments 242 and 244, respectively, as shown in FIG. 8b, so as to increase the amount of illumination that is reflected to imaging assembly 262.

The structure of bezel segment 244 is shown in further detail in FIG. 9. In this embodiment, bezel segment 244 comprises two adjacently positioned plastic films in which faceted multi-angle reflectors 400 and 402 are formed.

Similar to assembly 122 described above, the faceted multi-angle reflectors 400 and 402 also comprise side facets 244d and 244f between mirror elements 244c and 244e, respectively. The side facets 244d and 244f are configured to reduce the amount of light reflected from the side facets 244d and 244f to the image sensor 170. Side facets 244d and 244f are oriented such that faces of facets 244d are not seen by imaging assembly 260 and faces of facet 244f are not seen by imaging assembly 262. These orientations reduce the amount of stray and ambient light that would otherwise be reflected from the side facets 244d and 244f to the image sensors 170. In this embodiment, side facets 244d and 244f are also coated with a non-reflective paint to further reduce the amount of stray and ambient light that would otherwise be reflected from the side facets 244d and 244f to the image sensors 170. Similar to mirror elements 240c, 242c, 244c and 244e, side facets 244d and 244f are sized in the submicrometer range and are generally smaller than the pixel resolution of the image sensors 170. Accordingly, the mirror elements and the side facets of assembly 222 do not reflect discrete images of the IR light source 290 to the image sensors 170.

When IR light source 290 is illuminated, the LEDs of the IR light source 290 flood the region of interest over the display surface 124 with infrared illumination. Infrared illumination 250 impinging on the faceted multi-angle reflectors 400 and 402 is returned to the image sensors 170 of imaging assemblies 260 and 262, respectively. IR light source 290 is configured so that the faceted multi-angle reflectors 400 and 402 are generally evenly illuminated over their entire lengths. As a result, in the absence of a pointer, each of the image sensors 170 of the imaging assemblies 260 and 262 sees a bright band 480 having a generally even intensity over its length.

When a pointer is brought into proximity with the display surface 124, the pointer occludes infrared illumination and as a result, dark regions corresponding to the pointer and interrupting the bright band appear in image frames captured by the image sensors 170, as illustrated in FIGS. 10a and 10b for image frames captured by the image sensors 170 of imaging assemblies 260 and 262, respectively. Here, dark regions 390 and 396 are caused by occlusion by the pointer of infrared illumination reflected from multi-angle reflectors 400 and 402, respectively, and as indicated by dotted lines 252 and 254, respectively. Dark regions 392 and 394 are caused by occlusion by the pointer of infrared illumination 250 emitted by IR light source 290, which casts a shadow on multi-angle reflector 400 and 402, respectively.

Each image frame output by the image sensor 170 is conveyed to the DSP 178 of the respective imaging assembly 260 or 262. When the DSP 178 receives an image frame, the DSP 178 processes the image frame to detect the existence of a pointer therein, as described in above-incorporated U.S. Pat. No. 6,803,906 to Morrison et al., and if a pointer exists, generates pointer data that identifies the position of the pointer within the image frame. The DSP 178 then conveys the pointer data to the master controller 126 via serial port 182 and communication lines 206.

When the master controller 126 receives pointer data from both imaging assembles 260 and 262, the master controller calculates the position of the pointer in (x,y) coordinates relative to the display surface 124 using Equations (3) and (4) above. The calculated pointer position is then conveyed by the master controller 126 to the general purpose computing device 128. The general purpose computing device 128 in turn processes the received pointer position and updates the image output provided to the display controller 130, if required, so that the image presented on the display surface 124 can be updated to reflect the pointer activity. In this manner, pointer interaction with the display surface 124 can be recorded as writing or drawing or used to control execution of one or more application programs running on the general purpose computing device 128.

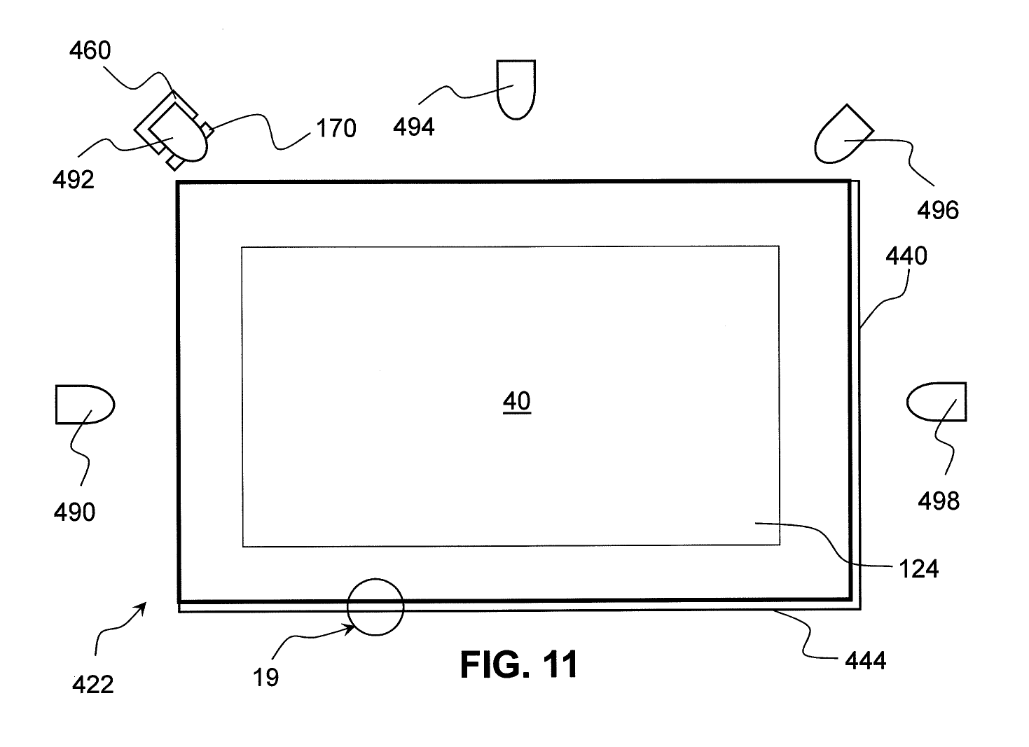

FIG. 11 shows another embodiment of an assembly for use with the interactive input system 20, and which is generally identified using reference numeral 422. Assembly 422 is similar to assembly 122 described above and with reference to FIGS. 1 to 6. However, assembly 422 comprises a plurality of IR light sources 490, 492, 494, 496 and 498. The IR light sources 490 through 498 are configured to be illuminated sequentially, such that generally only one of the IR light sources 490 through 498 illuminates the region of interest 40 at a time.

Similar to assembly 122, assembly 422 comprises a bezel which has two bezel segments 440 and 444. Bezel segment 440 extends along a right side of the display surface 124, while bezel segment 444 extends along a bottom side of the display surface 124. The bezel segments 440 and 444 are oriented so that their inwardly facing surfaces are generally normal to the plane of the display surface 124. Assembly 422 also comprises a single imaging assembly 460 that comprises an image sensor 170 positioned adjacent the upper left corner of the assembly 422. Image sensor 170 is oriented so that its field of view looks generally across the entire display surface 124 towards bezel segments 440 and 444.

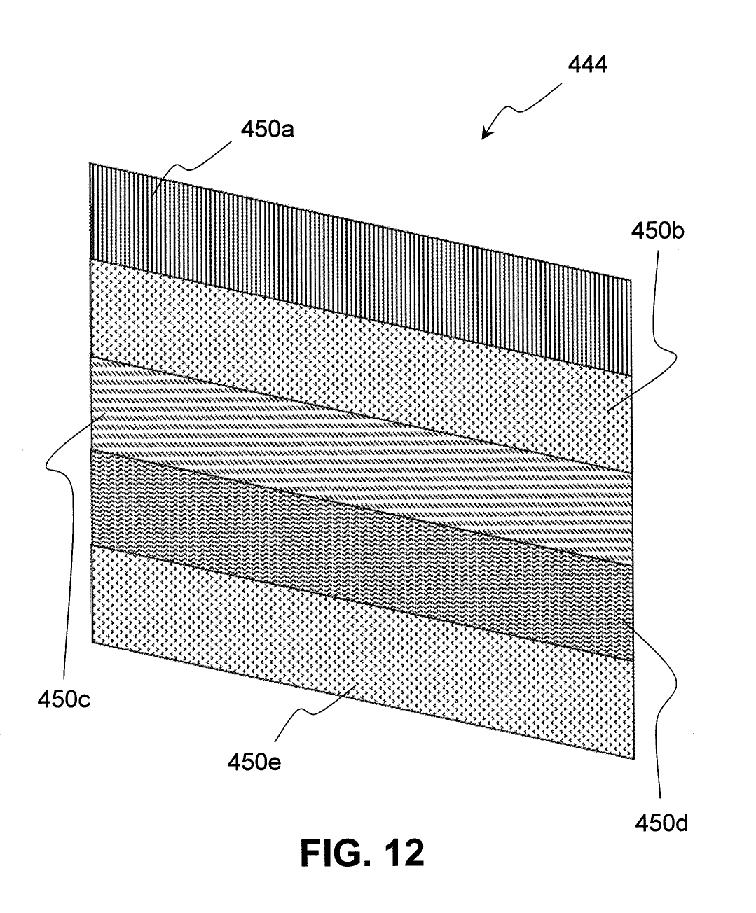

In this embodiment bezel segments 440 and 444 comprise a backing having an inwardly directed surface on which a plurality of plastic films are disposed. Each of the plastic films is machined and engraved to form a respective faceted multi-angle reflector. The structure of bezel element 444 is shown in further detail in FIG. 12. Bezel segment 444 comprises a plurality of faceted multi-angle reflectors 450a, 450b, 450c, 450d and 450e that are arranged adjacently on the bezel segment. As with the multi-angle reflectors described in the embodiments above, the facets of the multi-angle reflectors 450a through 450e define a series of highly reflective, generally planar mirror elements (not shown) extending the length of the plastic film.

The mirror elements of each of the five (5) multi-angle reflectors 450a, 450b, 450c, 450d and 450e are configured to each reflect illumination emitted from a respective one of the five (5) IR light sources to the image sensor 170 of imaging assembly 260. Here, the mirror elements of multi-angle reflector 450a, 450b, 450c, 450d and 450e are configured to reflect illumination emitted by IR light source 490, 492, 494, 496 and 498, respectively, towards the image sensor 170. The angle of consecutive mirror elements of each of the multi-angle reflectors 450a through 450e is varied incrementally along the length of the bezel segments 440 and 444 so as to increase the amount of illumination that is reflected to the image sensor 170. Similar to assembly 122 described above, the widths of the mirror elements of the multi-angle reflectors 450a through 450e are in the sub-micrometer range, and thereby do not reflect discrete images of the IR light sources 490 through 498 to the image sensors 170.

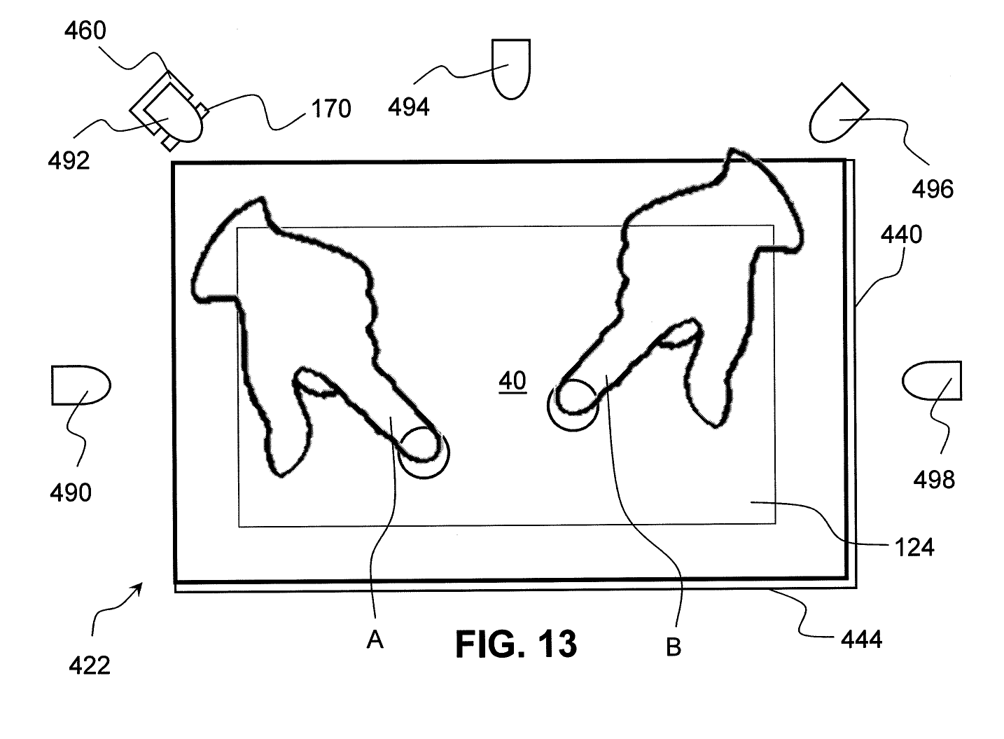

FIG. 13 shows an interaction of two pointers with the assembly 422. Here, two pointers A and B have been brought into proximity with the region of interest 40, and are within the field of view of image sensor 170 of the imaging assembly 460. The image sensor 170 captures images of the region of interest 40, with each image frame being captured as generally only one of the IR light sources 490 through 498 is illuminated.

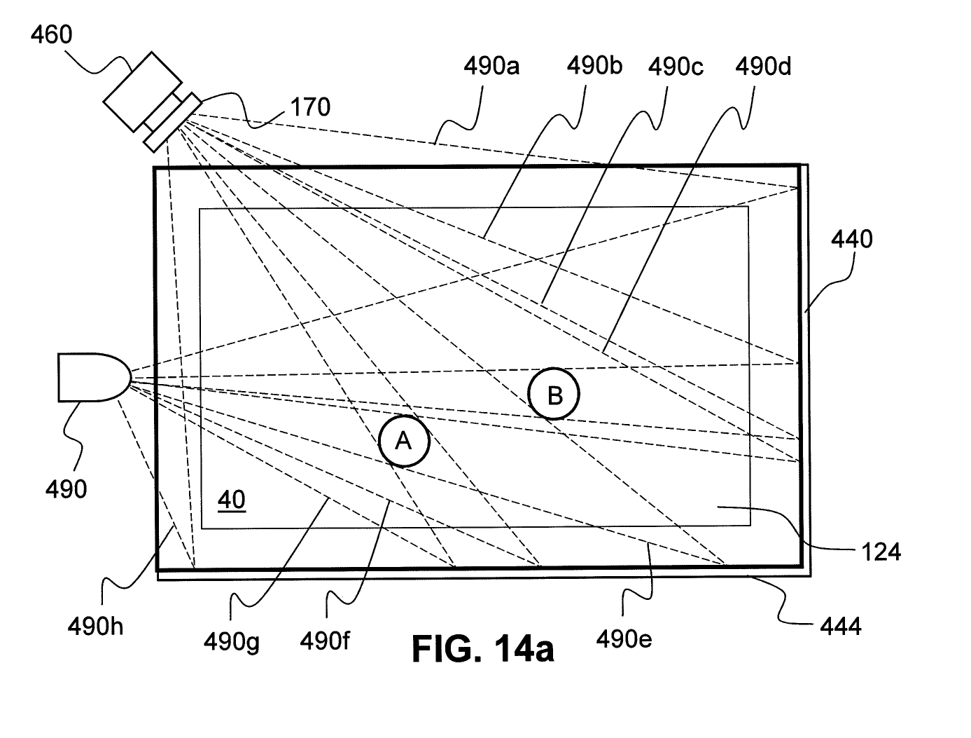

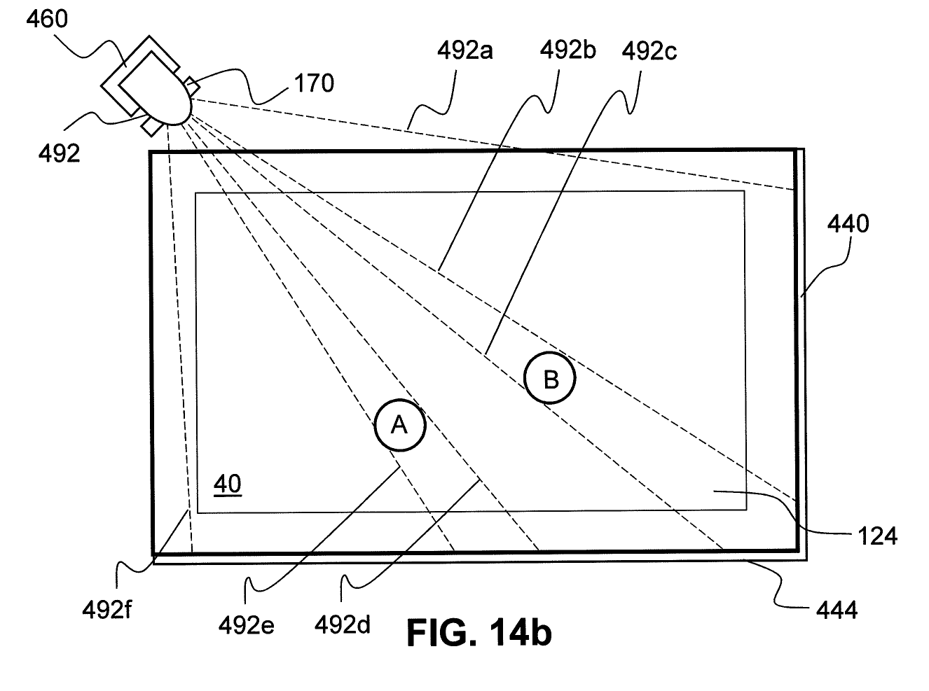

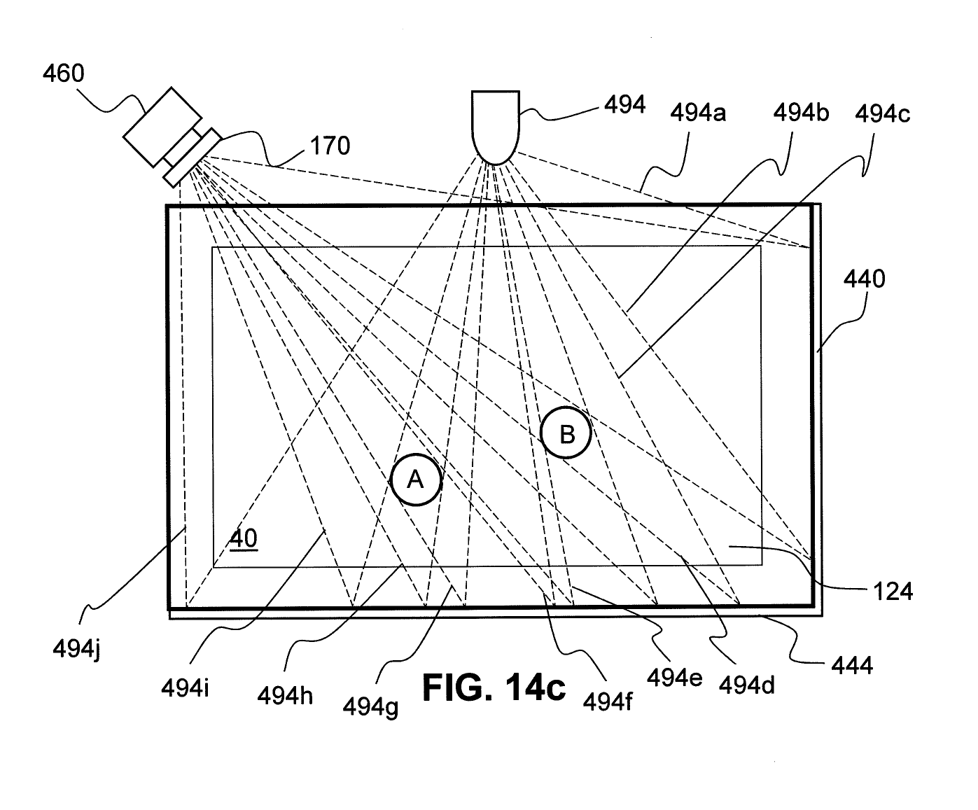

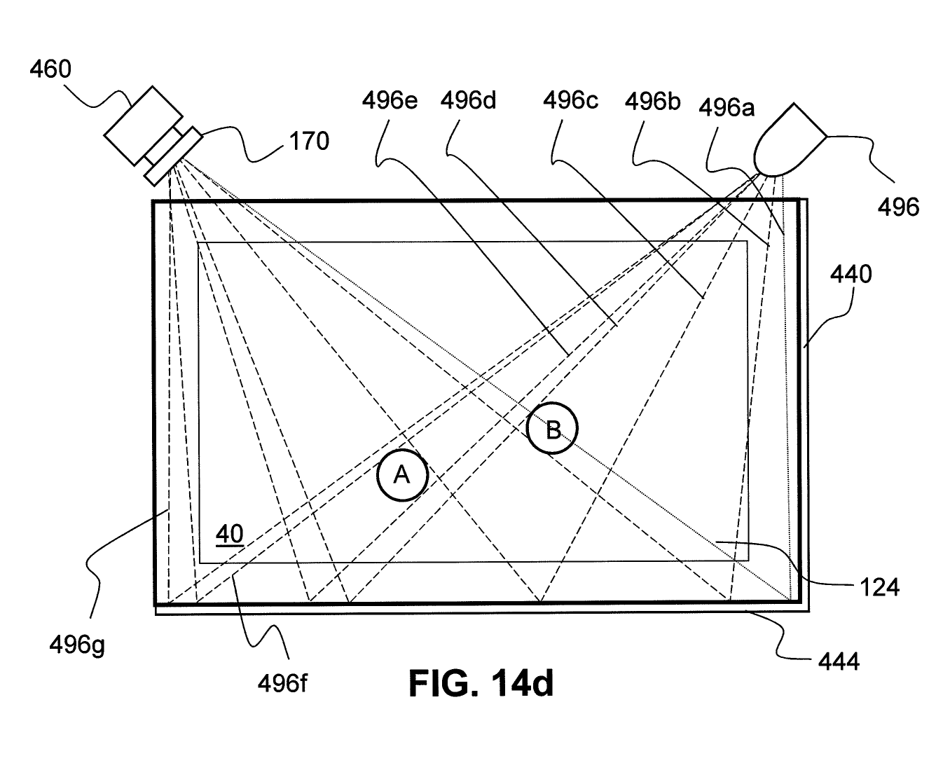

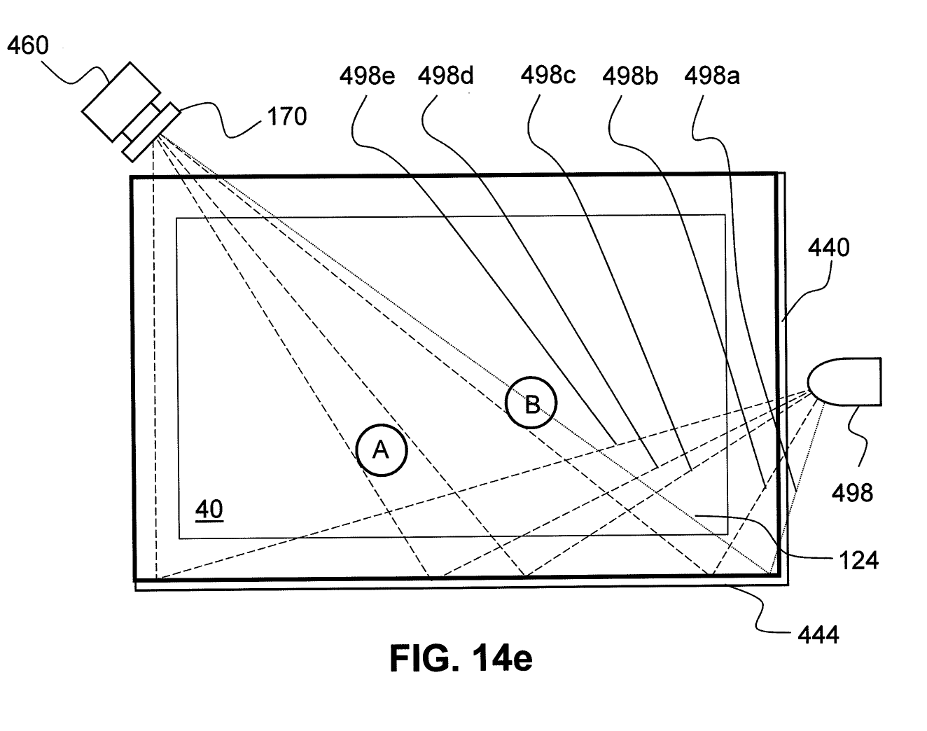

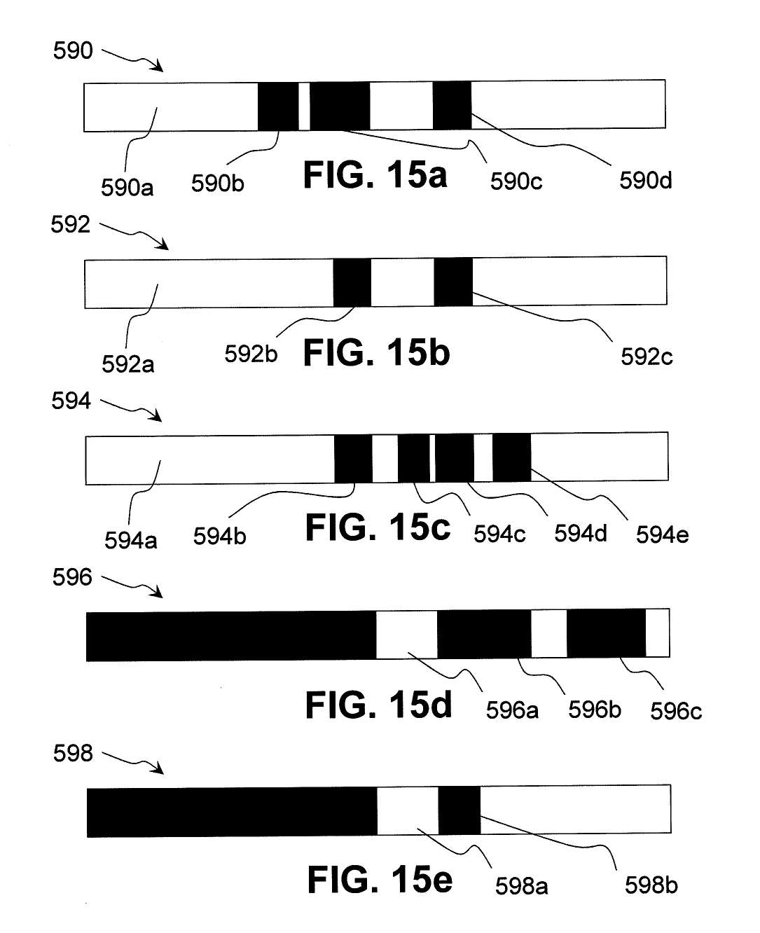

The interaction between the pointers A and B and the illumination emitted by each of the light sources 490 to 498 is shown in FIGS. 14a to 14e, respectively. For example, FIG. 14a shows the interaction of pointers A and B with illumination emitted by light source 490. As shown in FIG. 15a, this interaction gives rise to a plurality of dark spots 590b, 590c, and 590d interrupting the bright band 590a on bezel segments 440 and 440, as seen by image sensor 170. These dark spots may be accounted for by considering a plurality of light paths 490a to 490h that result from the interaction of pointers A and B with the infrared illumination, as illustrated in FIG. 14a. Dark spot 590b is caused by occlusion by pointer B of illumination emitted by light source 490, where the occlusion is bounded by light paths 490b and 490c. Dark spot 590c is caused by occlusion by pointer A of illumination emitted by light source 490, where the occlusion is bounded by light paths 490d and 490e. Dark spot 590d is formed by occlusion by pointer A of illumination emitted by light source 490 that has been reflected from bezel segment 444, and where the occlusion is bounded by light paths 490f and 490g.

As light sources 490 to 498 each have different positions with respect to the region of interest 40, the interaction of pointers A and B with illumination emitted by each of the light sources 490 to 498 will be different, as illustrated in FIGS. 14a to 14e. Here, any of the number, sizes and positions of dark spots interrupting the bright film on bezel segments 440 and 440 as seen by image sensor 170 will vary as light sources 490 to 498 are sequentially illuminated. These variations are illustrated in FIGS. 15a to 15e.

During operation, DSP 178 of imaging assembly 460 generates clock signals so that the image sensor 170 captures image frames at a desired frame rate. The DSP 178 also signals the current control module 188 of imaging assembly 460. In response, each current control module 188 connects one of IR light sources 490, 492, 494, 496 and 498 to the power supply 192. When each of the IR light sources 490 through 498 is on, each LED of the IR light source 490 through 498 floods the region of interest over the display surface 124 with infrared illumination. The infrared illumination emitted by the IR light sources 490, 492 and 494 that impinges on the mirror elements of bezel segments 440 and 444 is returned to the image sensor 170 of the imaging assembly 460. As a result, in the absence of a pointer within the field of view of the image sensor 170, the bezel segments 440 and 444 appear as a bright “white” band having a substantially even intensity over its length in image frames captured by the image sensor 170. The infrared illumination emitted by the IR light sources 496 and 498 that impinges on the mirror elements of bezel segment 444 is returned to the image sensor 170 of the imaging assembly 460. Owing to their positions, the infrared illumination emitted by IR light sources 496 and 498 does not impinge on the mirror elements of bezel segment 440. As a result, in the absence of a pointer within the field of view of the image sensor 170, the bezel segments 440 and 444 appear as “dark” and bright “white” bands, respectively, each having a substantially even intensity over its respective length in image frames captured by the imaging assembly 460.

When a pointer is brought into proximity with the display surface 124, the pointer occludes infrared illumination and as a result, dark regions corresponding to the pointer and interrupting the bright band appear in image frames captured by the imaging assembly 460, as shown in FIGS. 15a to 15e. Each image frame output by the image sensor 170 of imaging assembly 460 is conveyed to the DSP 178. When the DSP 178 receives an image frame, the DSP 178 processes the image frame to detect the existence of a pointer therein and if it is determined that a pointer exists, generates pointer data that identifies the position of the pointer and occluded reflection within the image frame. The DSP 178 then conveys the pointer data to the master controller 126 via serial port 182 and communication lines 206.

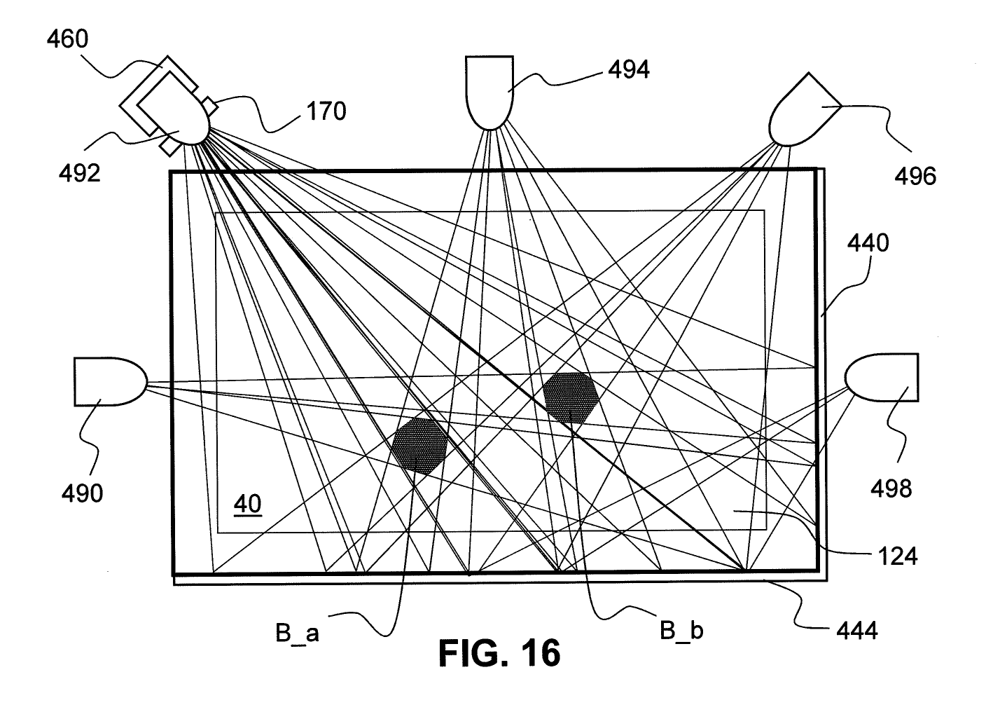

When the master controller 126 receives pointer data from DSP 178, the master controller calculates the position of the pointer in (x,y) coordinates relative to the display surface 124 using well known triangulation techniques. The approximate size of the pointer is also determined using the pointer data to generate a bounding area for each pointer. In this embodiment, the presence of two pointers A and B generates two bounding areas B_a and B_b, as shown in FIG. 16. Here, the bounding areas B_a and B_b correspond to occlusion areas formed by overlapping the bounding light paths, illustrated in FIGS. 14a to 14e, that result from the interactions of illumination emitted by each of light sources 490 to 498 with the pointers A and B. As shown, the bounding areas B_a and B_b are multi-sided polygons that approximate the size and shape of pointers A and B.

The calculated position, size and shape for each pointer are each then conveyed by the master controller 126 to the general purpose computing device 128. The general purpose computing device 128 in turn processes the received pointer position and updates the image output provided to the display controller 130, if required, so that the image presented on the display surface 124 can be updated to reflect the pointer activity. The general purpose computing device 128 may also use the pointer size and shape information to modify object parameters, such as the size and profile of a paintbrush, in software applications as required. In this manner, pointer interaction with the display surface 124 can be recorded as writing or drawing or used to control execution of one or more application programs running on the general purpose computing device 128.

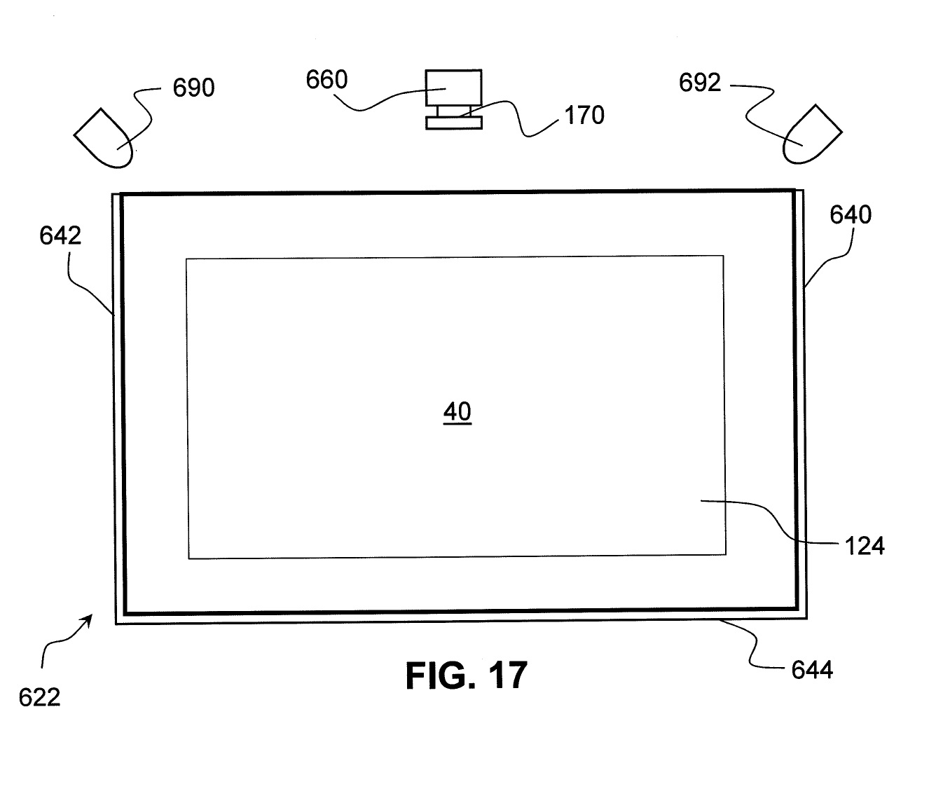

FIG. 17 shows another embodiment of an assembly for use with the interactive input system 100, and which is generally indicated by reference numeral 622. Assembly 622 is similar to assembly 422 described above and with reference to FIGS. 11 to 16, in that it comprises a single image sensor and a plurality of IR light sources. However, assembly 622 comprises a bezel having three (3) bezel segments 640, 642 and 644. As with assembly 422 described above, assembly 622 comprises a frame assembly that is mechanically attached to the display unit and surrounds a display surface 124. Bezel segments 640 and 642 extend along right and left edges of the display surface 124 while bezel segment 644 extends along the bottom edge of the display surface 124. The bezel segments 640, 642 and 644 are oriented so that their inwardly facing surfaces are generally normal to the plane of the display surface 124. Assembly 622 also comprises an imaging assembly 660 comprising an image sensor 170. In this embodiment, the image sensor 170 is positioned generally centrally between the upper left and upper right corners of the assembly 622, and is oriented so that its field of view looks generally across the entire display surface 124 and sees bezel segments 640, 642 and 644.

In this embodiment, bezel segments 640, 642 and 644 each comprise a backing having an inwardly directed surface on which plastic films (not shown) are disposed. The plastic films are machined and engraved to form faceted multi-angle reflectors 680 (not shown) and 682 (not shown), respectively. The facets of the multi-angle reflectors 680 and 682 define a series of highly reflective, generally planar mirror elements extending the length of the plastic films. The plastic film forming multi-angle reflector 680 is disposed on bezel segments 642 and 644, and the mirror elements of the multi-angle reflector 680 are configured to each reflect illumination emitted by IR light source 690 to the image sensor 170. The plastic film forming multi-angle reflector 682 is disposed on bezel segments 640 and 644, and the mirror elements of the multi-angle reflector 682 are configured to each reflect illumination emitted by IR light source 692 to the image sensor 170. As in the embodiments described above, the mirror elements of the multi-angle reflectors 680 and 682 are sized so they are smaller than the pixel resolution of the image sensor 170 and, in this embodiment, the mirror elements are in the sub-micrometer range.

The structure of bezel segment 644 is generally similar to that of bezel segment 244 that forms part of assembly 222, described above and with reference to FIG. 9. Bezel segment 644 contains both multi-angle reflectors 680 and 682 positioned adjacently to each other. In this embodiment, the plastic films forming multi-angle reflectors 680 and 682 are each formed of individual plastic strips that are together disposed on a common backing on bezel segment 644. The structures of bezel segments 640 and 642 differ from that of bezel segment 644, and instead each comprise a single plastic film forming part of multi-angle reflector 680 or 682, respectively.

During operation, the DSP 178 of imaging assembly 660 generates clock signals so that the image sensor 170 of the imaging assembly captures image frames at a desired frame rate. The DSP 178 also signals the current control module 188 of IR light source 690 or 692. In response, each current control module 188 connects its associated IR light source 690 or 692 to the power supply 192. When the IR light sources 690 and 692 are on, each LED of the IR light sources 690 and 692 floods the region of interest over the display surface 124 with infrared illumination. The IR light sources 690 and 692 are controlled so that each light is illuminated discretely, and so that generally only one IR light source is illuminated at any given time and that image sensor 170 of imaging assembly 660 detects light from generally only one IR light source 690 or 692 during any captured frame. Infrared illumination emitted by IR light source 690 that impinges on the multi-angle reflector 680 of the bezel segments 640 and 644 is returned to the image sensor 170 of the imaging assembly 660. Infrared illumination emitted by IR light source 692 that impinges on the multi-angle reflector 682 of the bezel segments 642 and 644 is returned to the image sensor 170 of the imaging assembly 660. As a result, in the absence of a pointer within the field of view of the image sensor 170, the bezel segments 640, 642 and 644 appear as a bright “white” band having a substantially even intensity over its length in image frames captured by the imaging assembly 660 during frames captured while IR light sources 690 and 692 are illuminated.

When a pointer is brought into proximity with the display surface 124, the pointer occludes infrared illumination and as a result, a dark region corresponding to the pointer and interrupting the bright film appears in image frames captured by the imaging assembly 660. Depending on the location of the pointer on the display surface 124, an additional dark region interrupting the bright film and corresponding to a shadow cast by the pointer on one of the bezel segments may be present.

Each image frame output by the image sensor 170 of imaging assembly 660 is conveyed to the DSP 178. When the DSP 178 receives an image frame, the DSP 178 processes the image frame to detect the existence of a pointer therein and if it is determined that a pointer exists, generates pointer data that identifies the position of the pointer within the image frame. The DSP 178 then conveys the pointer data to the master controller 126 via serial port 182 and communication lines 206.

When the master controller 126 receives pointer data from imaging assembly 660, the master controller calculates the position of the pointer in (x,y) coordinates relative to the display surface 124 using well known triangulation techniques. The calculated pointer position is then conveyed by the master controller 126 to the general purpose computing device 128. The general purpose computing device 128 in turn processes the received pointer position and updates the image output provided to the video controller 130, if required, so that the image presented on the display surface 124 can be updated to reflect the pointer activity. In this manner, pointer interaction with the display surface 124 can be recorded as writing or drawing or used to control execution of one or more application programs running on the general purpose computing device 128.

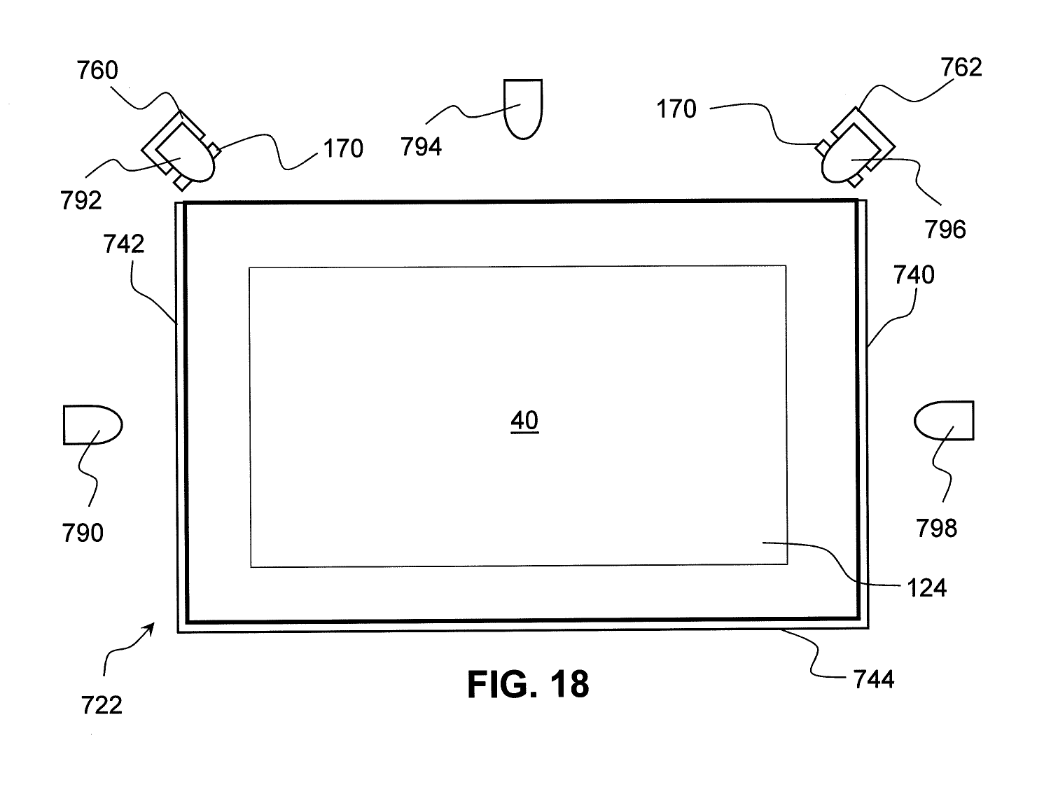

FIG. 18 shows still another embodiment of an assembly for use with the interactive input system 100, and which is generally indicated by reference numeral 722. Assembly 722 is similar to assembly 422 described above and with reference to FIGS. 11 to 16, in that it comprises a plurality of IR light sources. However, similar to assembly 222 described above and with reference to FIGS. 7 to 10, assembly 722 comprises two (2) image sensors. Here, assembly 722 comprises a frame assembly that is mechanically attached to the display unit and surrounds the display surface 124. Assembly 722 also comprises a bezel having three bezel segments 740, 742 and 744. Bezel segments 740 and 742 extend along right and left edges of the display surface 124 while bezel segment 744 extends along the bottom edge of the display surface 124. The bezel segments 740, 742 and 744 are oriented so that their inwardly facing surfaces are generally normal to the plane of the display surface 124. Imaging assemblies 760 and 762 are positioned adjacent the upper left and right corners of the assembly 722, and are oriented so that their fields of view overlap and look generally across the entire display surface 124. In this embodiment, imaging assembly 760 sees bezel segments 740 and 744, while imaging assembly 762 sees bezel segments 742 and 744.

In this embodiment, bezel segments 740, 742 and 744 comprise a backing having an inwardly directed surface on which a plurality of plastic films are disposed. In this embodiment, the plastic films are each formed of a single plastic strip and are machined and engraved to form respective faceted multi-angle reflectors 780a through 780j (not shown). Multi-angle reflectors 780a, 780c and 780e are disposed on both bezel segments 740 and 744, while multi-angle reflectors 780f, 780h and 780j are disposed on both bezel segments 742 and 744. Multi-angle reflectors 780b, 780d, 780g and 780i are disposed on bezel segment 744 only.

As with the multi-angle reflectors described in the embodiments above, the facets of the multi-angle reflectors 780a through 780j define a series of highly reflective, generally planar mirror elements (not shown). The mirror elements of the multi-angle reflector 780a, 780c, 780e, 780g and 780i are configured to each reflect illumination emitted by IR light source 790, 792, 794, 796 and 798, respectively, to the image sensor 170 of imaging assembly 760. The mirror elements of the multi-angle reflector 780b, 780d, 780f, 780h and 780j are configured to each reflect illumination emitted by IR light source 790, 792, 794, 796 and 798, respectively, to the image sensor 170 of imaging assembly 762. As with the multi-angle reflectors described in the embodiments above, the mirror elements are sized so that they are smaller than the pixel resolution of the image sensors 170 of the imaging assemblies 760 and 762 and in this embodiment, the mirror elements are in the sub-micrometer range.

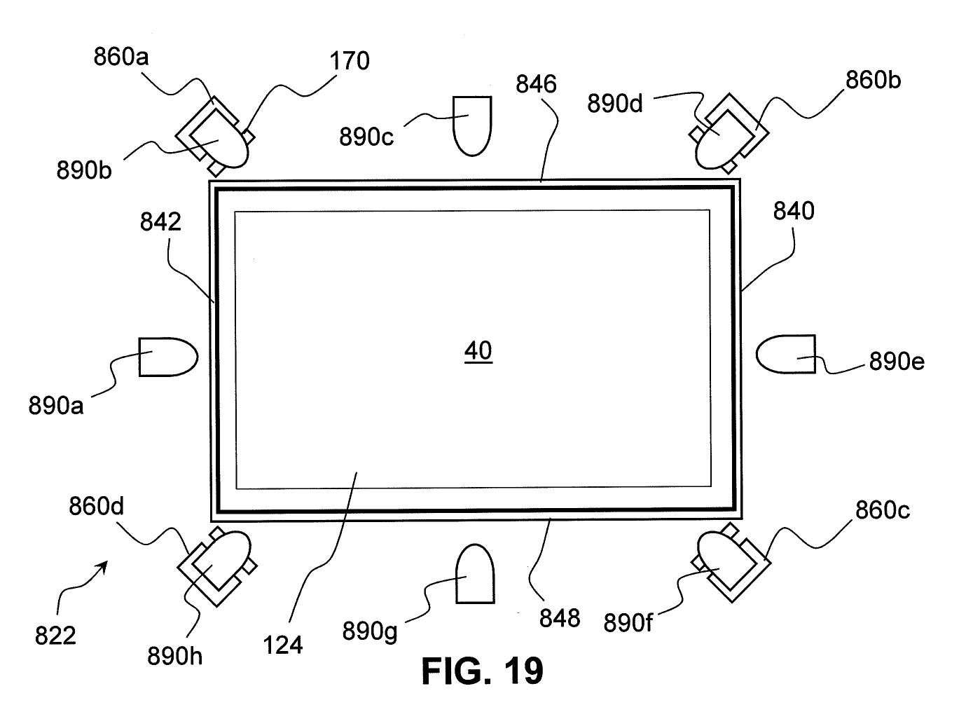

FIG. 19 shows still yet another embodiment of an assembly for use with the interactive input system 100, and which is generally indicated by reference numeral 822. Assembly 822 is generally similar to assembly 722 described above and with reference to FIG. 17, however assembly 822 employs four (4) imaging assemblies, eight (8) IR light sources and four (4) bezel segments. Here, assembly 822 comprises bezel segments 840 and 842 that extend along right and left edges of the display surface 124, respectively, while bezel segments 844 and 846 extend along the top and bottom edges of the display surface 124, respectively. The bezel segments 840, 842, 844 and 846 are oriented such that their inwardly facing surfaces are generally normal to the plane of the display surface 124. Assembly 822 also comprises imaging assemblies 860a, 860b, 860c and 860d positioned adjacent each of the four corners of the display surface 124. Imaging assemblies 860a, 860b, 860c and 860d each comprise a respective image sensor 170, whereby each of the image sensors 170 looks generally across the entire display surface 124 and sees bezel segments.

Assembly 822 comprises eight IR light sources 890a through 890h. IR light sources 890a, 890c, 890e and 890g are positioned adjacent the sides of the display surface 124, while IR light sources 890b, 890d, 890f and 890h are positioned adjacent each of the corners of the region of the display surface 124.

In this embodiment, bezel segments 840 to 846 each comprise a backing having an inwardly facing surface on which twenty-eight (28) plastic films (not shown) are disposed. The plastic films are machined and engraved to form faceted multi-angle reflectors 880₁ through 880₂₈ (not shown). The multi-angle reflectors 880₁ through 880₂₈ are disposed on bezel segments 840 to 846. The facets of the multi-angle reflectors 880₁ through 880₂₈ define a series of highly reflective, generally planar mirror elements extending the length of the bezel segments.

The IR light sources 890a through 890h are controlled so that each light is illuminated individually and sequentially, and such that generally only one IR light source is illuminated at any given time. As will be understood, the configuration of the imaging assemblies, the IR light sources and the bezel segments of assembly 822 gives rise to twenty-eight (28) unique illumination combinations. Each of the twenty-eight (28) combinations is captured in a respective image frame. Here, when one of the IR light sources 890b, 890d, 890f and 890h positioned adjacent the corners of display surface 124 is illuminated, the image sensor 170 positioned adjacent the opposite corner of display surface 124 and facing the illuminated IR light source is configured to not capture an image frame.

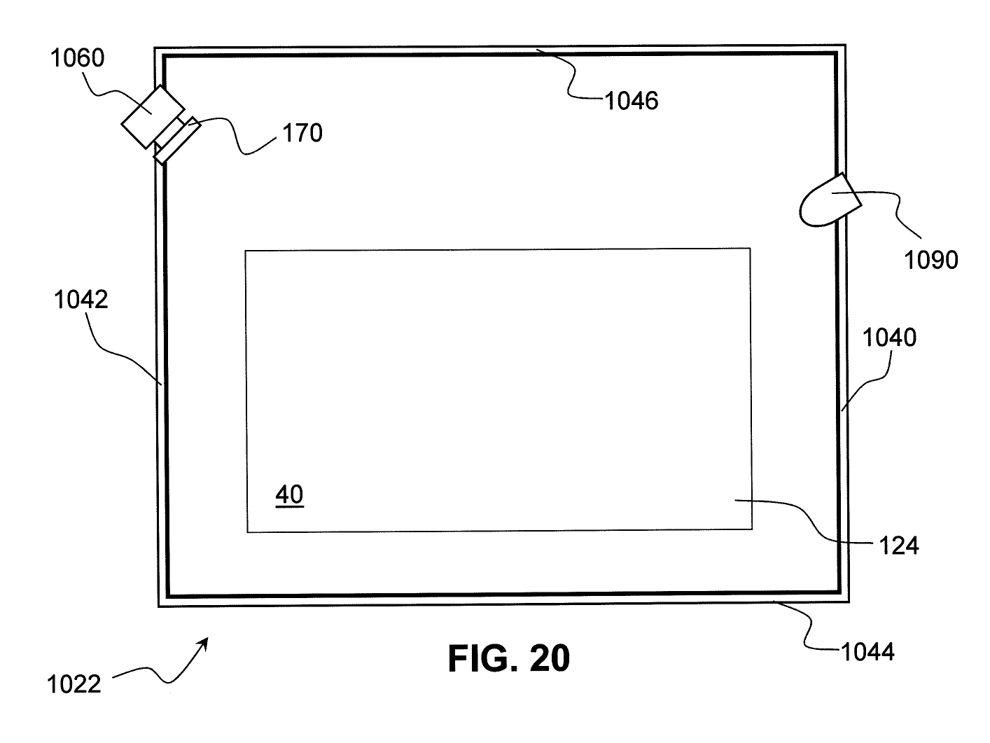

FIG. 20 shows still another embodiment of an assembly for use with the interactive input system 100, and which is generally indicated using reference numeral 1022. Assembly 1022 is generally similar to assembly 122 described above and with reference to FIGS. 1 to 6 in that it comprises a single imaging assembly and a single IR light source, however assembly 1022 comprises a bezel having four (4) bezel segments 1040, 1042, 1044 and 1046. Here, assembly 1022 comprises a frame assembly that is mechanically attached to a display unit and surrounds a display surface 124. The bezel segments 1040, 1042, 1044 and 1046 are generally spaced from the periphery of the display surface 124, as shown in FIG. 20. Bezel segments 1040 and 1042 extend generally parallel to right and left edges of the display surface 124 while bezel segments 1044 and 1046 extend generally parallel to the bottom and top edges of the display surface 124. The bezel segments 1040, 1042, 1044 and 1046 are oriented so that their inwardly facing surfaces are generally normal to the plane of the region of interest 40. Assembly 1022 also comprises an imaging assembly 1060 positioned adjacent the upper left corner of the assembly 1022. Imaging assembly 1060 comprises an image sensor 170 that is oriented so that its field of view looks generally across the entire display surface 124 and sees bezel segments 1040 and 1044.

In this embodiment, each of bezel segments 1040, 1042 and 1046 comprises a backing having an inwardly directed surface on which a respective plastic film (not shown) is disposed. Bezel segment 1044 comprises a backing having an inwardly directed surface on which two plastic films (not shown) are disposed. The plastic films are machined and engraved to form faceted multi-angle reflectors 1080 through 1088 (not shown). Here, bezel segment 1040, 1042 and 1046 comprises multi-angle reflector 1080, 1082 and 1088, respectively, while bezel segment 1044 comprises multi-angle reflectors 1084 and 1086.

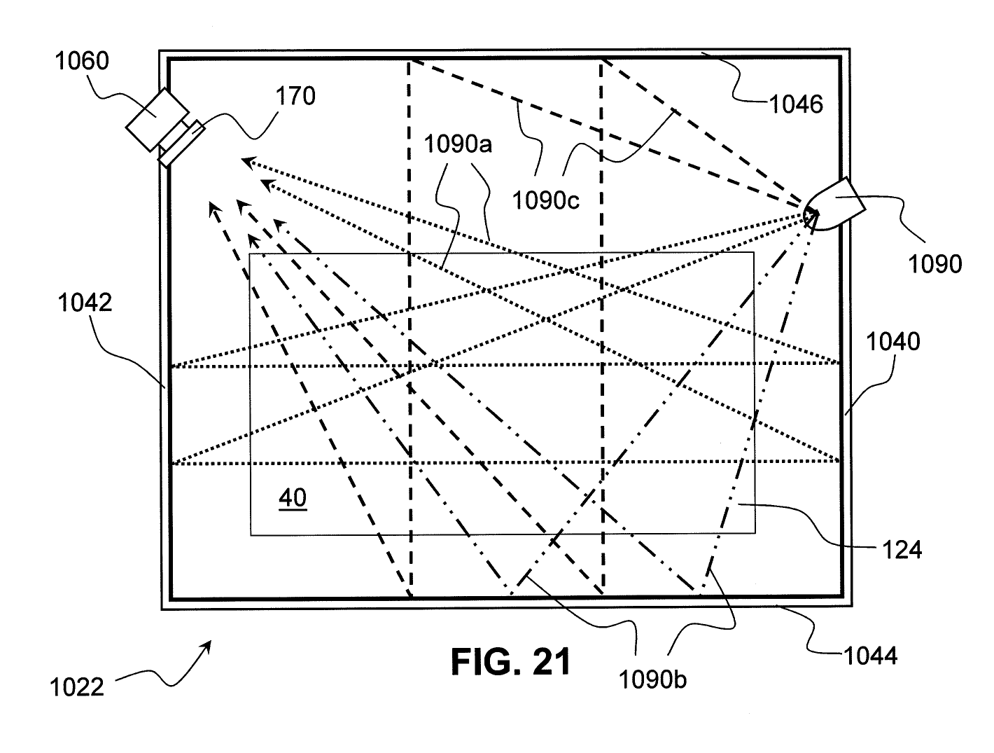

As with the multi-angle reflectors described in the embodiments above, the facets of the multi-angle reflectors 1080 through 1088 define a series of highly reflective, generally planar mirror elements (not shown). Each mirror element of the multi-angle reflector 1082 on bezel segment 1042 is angled so that illumination emitted by IR light source 1090 is reflected at an angle of reflection that is generally perpendicular to bezel segment 1042. Each mirror element of the multi-angle reflector 1080 on bezel segment 1040 is angled such that light reflected by multi-angle reflector 1080 is in turn reflected towards a focal point generally coinciding with the image sensor 170 of imaging assembly 1060, as indicated by light path 1090a in FIG. 21. Each mirror element of multi-angle reflector 1088 is angled so that illumination emitted by IR light source 1090 is reflected at an angle of reflection that is generally perpendicular to bezel segment 1046. Each mirror element of the multi-angle reflector 1084 is angled such that light reflected by multi-angle reflector 1088 is in turn reflected towards a focal point generally coinciding with the image sensor 170 of imaging assembly 1060, as indicated by light path 1090c in FIG. 21. Each mirror element of the multi-angle reflector 1086 is angled such that illumination emitted by IR light source 1090 is reflected towards a focal point generally coinciding with the image sensor 170 of imaging assembly 1060, as indicated by light path 1090b in FIG. 21. In this manner, the mirror elements of the multi-angle reflectors 1080 through 1088 are generally configured to each reflect illumination emitted by IR light source 1090 to the image sensor 170 of imaging assembly 1060. The mirror elements are sized so as to be smaller than the pixel resolution of the image sensor 170 of the imaging assembly 1060. In this embodiment, the mirror elements are in the sub-micrometer range.

During operation, a DSP 178 (not shown) of the imaging assembly 1060 generates clock signals so that the image sensor 170 of the imaging assembly captures image frames at a desired frame rate. The DSP 178 also signals the current control module of IR light source 1090. In response, the current control module connects IR light source 1090 to the power supply 192. When the IR light sources 1090 is on, each LED of the IR light sources 1090 floods the region of interest over the display surface 124 with infrared illumination. The IR light source 1090 is controlled so that the IR light source 1090 is illuminated so that image sensor 170 captures infrared illumination from IR light source 1090 during each captured image frame. Infrared illumination emitted by IR light source 1090 that impinges on the multi-angle reflector 1082 of the bezel segment 1042 is reflected towards multi-angle reflector 1080 of the bezel segment 1040 and is returned to the image sensor 170 of the imaging assembly 1060. Infrared illumination emitted by IR light source 1090 that impinges on the multi-angle reflector 1084 of the bezel segment 1044 is returned to the image sensor 170 of the imaging assembly 1060. Infrared illumination emitted by IR light source 1090 that impinges on the multi-angle reflector 1088 of the bezel segment 1046 is reflected towards multi-angle reflector 1086 of the bezel segment 1044 and is returned to the image sensor 170 of the imaging assembly 1060. As a result, in the absence of a pointer within the field of view of the image sensor 170, the bezel segments 1040 and 1044 appear as a bright “white” band having a substantially even intensity over its length in image frames captured by the imaging assembly 1060 during frames captured while IR light source 1090 is illuminated.

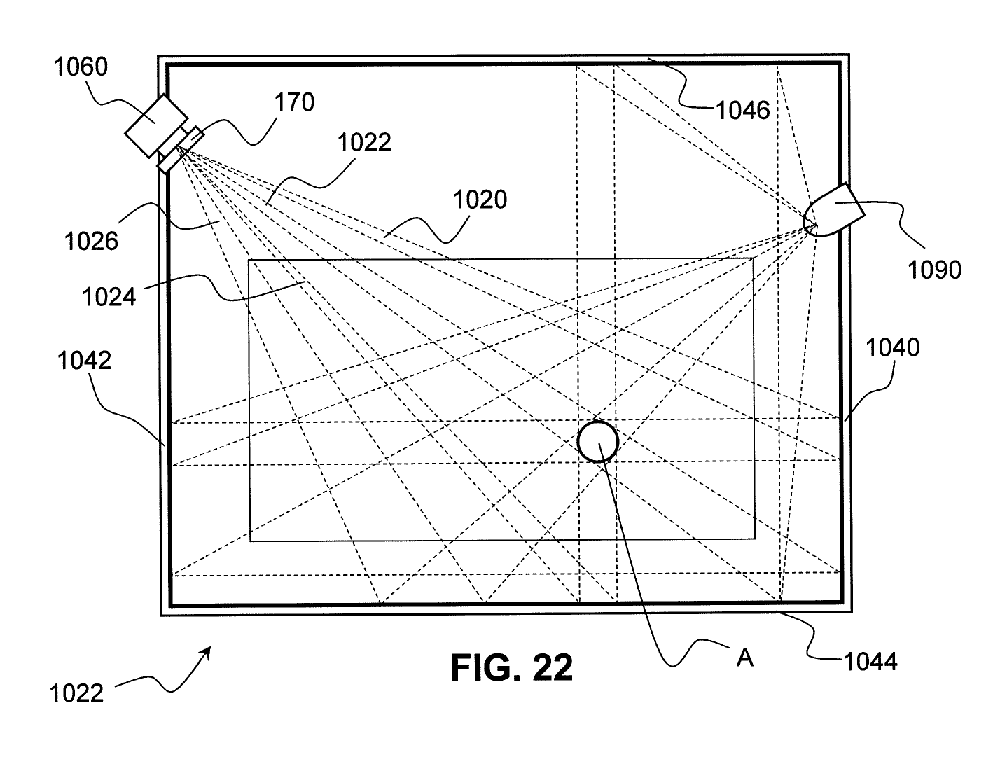

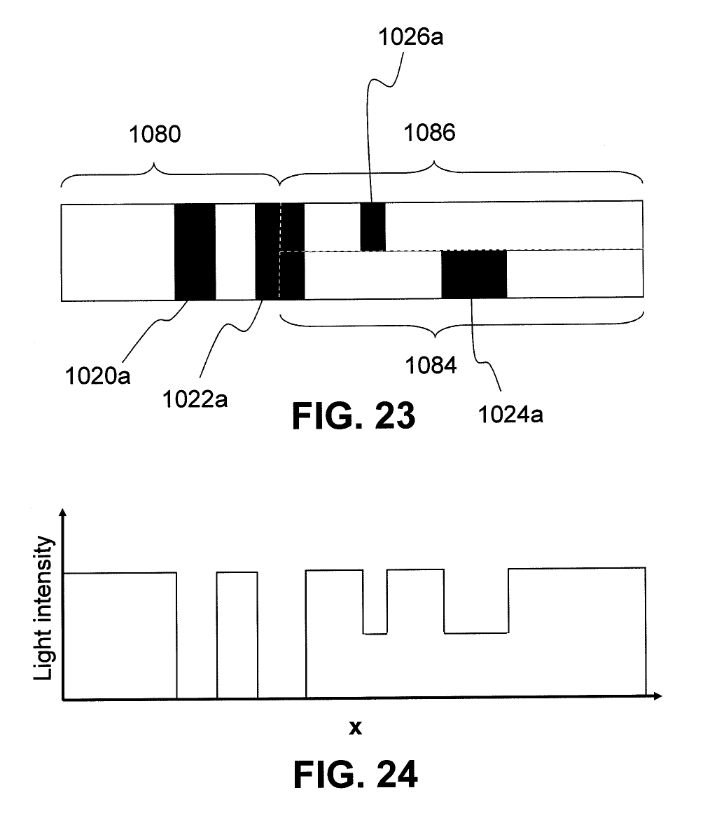

FIG. 22 shows a point A indicating the location of a pointer brought into proximity with the region of interest 40 of assembly 1022. The dotted lines indicate light paths of illumination emitted by IR light source 1090 and passing adjacent point A. When a pointer is brought into proximity with the display surface 124, the pointer occludes infrared illumination, and as a result dark regions corresponding to the pointer appear in image frames captured by the imaging assembly 1060. FIG. 23 is an image frame captured by the imaging assembly during use. Here, dark region 1020a is caused by occlusion by the pointer of infrared illumination that has reflected from multi-angle reflector 1082 on bezel segment 1042, and which in turn has been reflected by multi-angle reflector 1080 on bezel segment 1040 towards the image sensor 170. Dark region 1022a is caused by occlusion by the pointer of infrared illumination that has been reflected from multi-angle reflectors 1080, 1082, and 1088 of bezel segments 1040, 1042 and 1044, respectively. Dark region 1024a is caused by occlusion by the pointer of infrared illumination emitted from the IR light source 1090, and which in turn has been reflected by multi-angle reflector 1088 on bezel segment 1044 towards the image sensor 170. Dark region 1026a is caused by occlusion by the pointer of infrared illumination reflected by multi-angle reflector 1088 on bezel segment 1044, and which in turn has been reflected by multi-angle reflector 1084 on bezel segment 1044.

Each image frame output by the image sensor 170 of imaging assembly 1060 is conveyed to the DSP 178. When the DSP 178 receives an image frame, the DSP 178 processes the image frame to detect dark regions indicating the existence of a pointer therein using a vertical intensity profile (VIP). A graphical plot of a VIP of the image frame of FIG. 23 is shown in FIG. 24. If a pointer is determined to exist based on an analysis of the VIP, the DSP 178 then conveys the pointer location information from the VIP analysis to the master controller 126 via serial port 182 and communication lines 206.

When the master controller 126 receives the pointer location data from the VIP analysis of imaging assembly 1060, the master controller calculates the position of the pointer in (x,y) coordinates relative to the display surface 124 using triangulation techniques similar to that described above. Based on the known positions of IR light source 1090, imaging assembly 1060, and multi-angle reflectors 1080, 1082, 1084, 1086 and 1088, the master controller 126 processes the pointer location data to approximate the size and shape of region surrounding contact point A.

The calculated pointer position, size and shape are then conveyed by the master controller 126 to the general purpose computing device 128. The general purpose computing device 128 in turn processes the received pointer position and updates the image output provided to the display controller 130, if required, so that the image presented on the display surface 124 can be updated to reflect the pointer activity. In this manner, pointer interaction with the display surface 124 can be recorded as writing or drawing or used to control execution of one or more application programs running on the general purpose computing device 128.

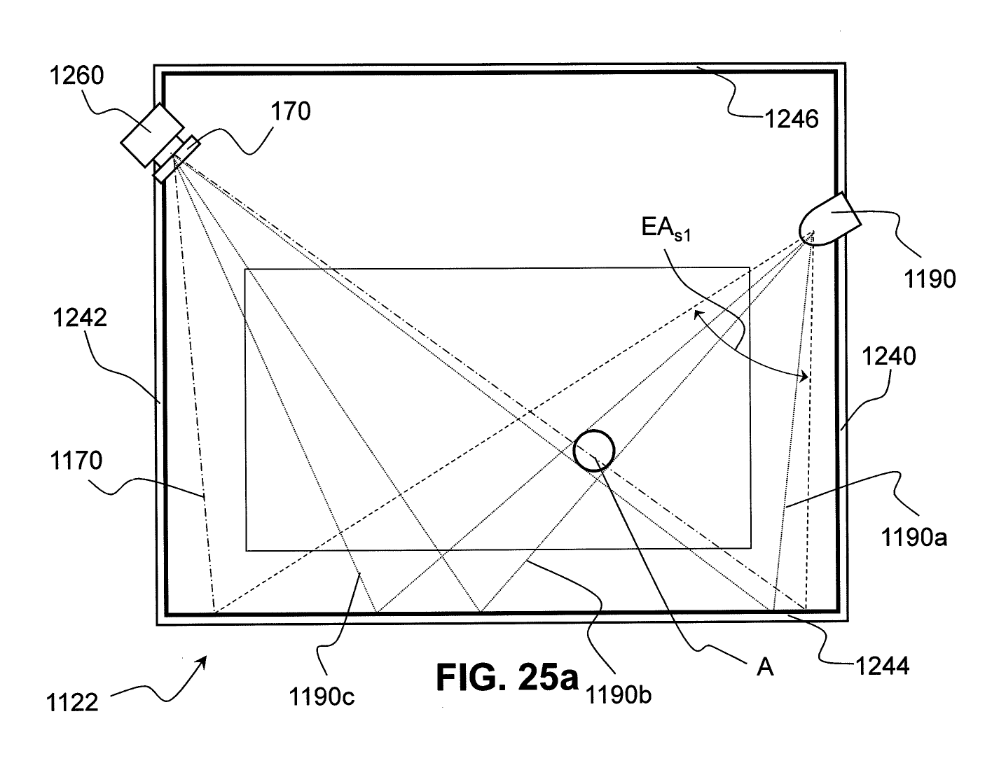

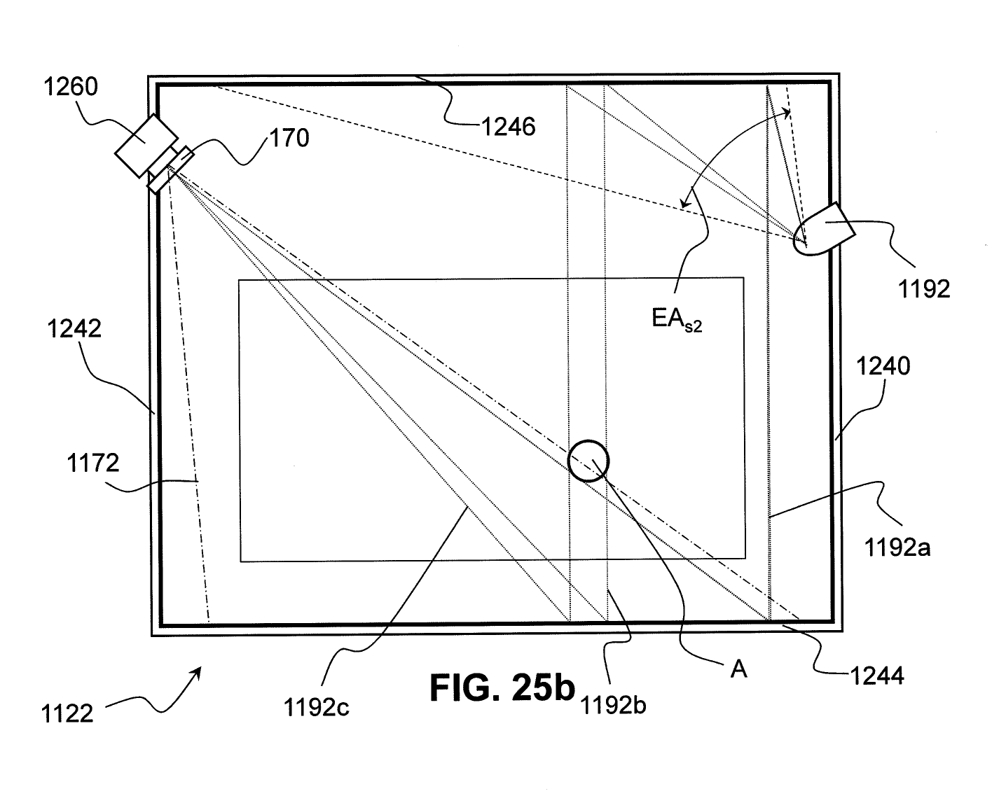

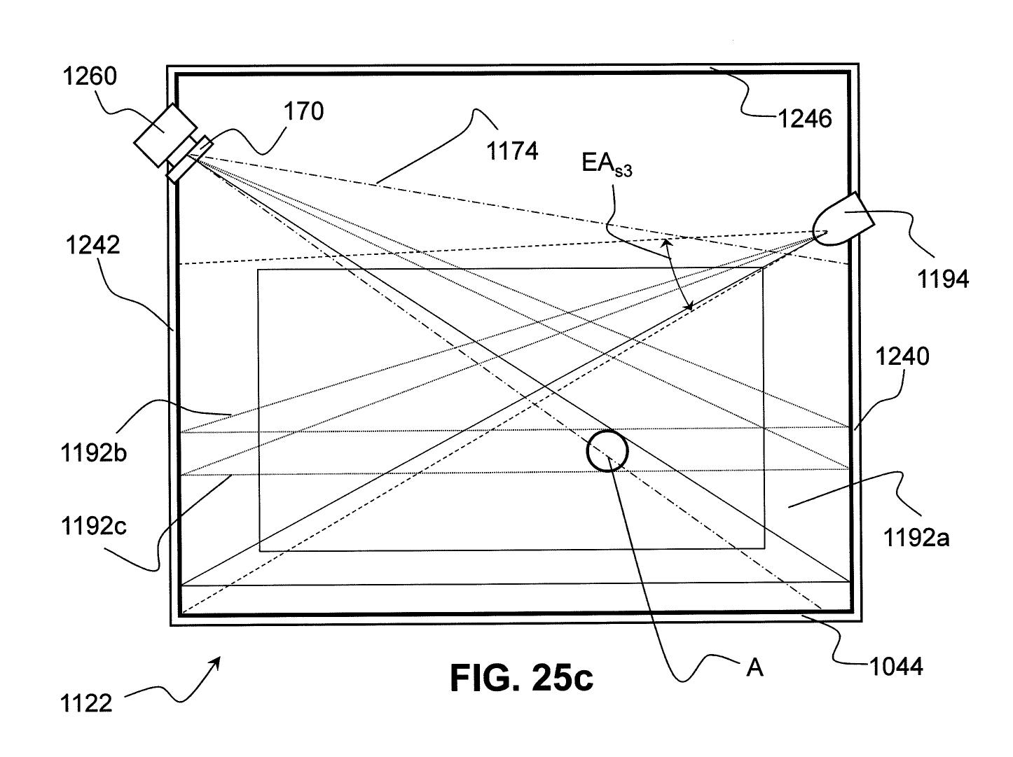

FIGS. 25a to 25c show still another embodiment of an assembly for use with the interactive input system 100, and which is generally indicated by reference numeral 1122. Assembly 1122 is generally similar to assembly 1022 described above and with reference to FIGS. 20 to 24, however assembly 1122 comprises three (3) IR light sources 1190, 1192 and 1194 that are positioned in a generally coincident positions. Here, IR light sources 1190, 1192 and 1194 are each configured to emit infrared illumination only towards bezel segment 1142, 1144 and 1146, respectively. The IR light sources 1190 through 1194 are also configured to be illuminated sequentially, such that generally only one of the IR light sources 1190 through 1194 illuminates the region of interest 40 at a time. Imaging assembly 1160 is configured such that image sensor 170 captures images when only one of IR light sources 1190 through 1194 is illuminated.

The respective emission angle EAₛ₁ to EAₛ₃ of each IR light source 1190 to 1194 is shown in FIGS. 25a to 25c, respectively. As may be seen in FIG. 25a, IR light source 1190 is configured to illuminate all or nearly all of multi-angle reflector 1184 of bezel segment 1144. Here, the dotted lines in each of FIGS. 25a to 25c indicate light paths defining boundaries of zones of occlusion of infrared illumination.

Imaging assembly 1160 has a field of view that encompasses both bezel segments 1140 and 1144. During operation the image sensor is synchronized to capture image frames while one of IR light sources 1190 through 1194 are illuminated. When IR light source 1190 is illuminated, imaging assembly 1160 captures an image frame using a first pixel subset of image sensor 170. The first pixel provides a field of view allowing imaging assembly 1160 to capture only bezel segment 1144, as indicated by dash-dot lines 1170 of FIG. 25a. As will be understood, by using only a pixel subset during image frame capture, the amount of data required processed by the DSP is reduced and the processing time is therefore reduced.

When IR light source 1192 is illuminated, imaging assembly 1160 captures an image frame using a second pixel subset of image sensor 170. The second pixel subset generally overlaps with the first pixel subset, and allows imaging assembly 1160 to capture only bezel segment 1144, as indicated by dash-dot line 1172 of FIG. 25b. When IR light source 1194 is illuminated, imaging assembly 1160 captures an image frame using a third pixel subset of image sensor 170. The third pixel subset is different from the first and second pixel subsets, and allows imaging assembly 1160 to capture only bezel segment 1140, as indicated by dash-dot line 1174 of FIG. 25c.

In the absence of a pointer within the field of view of the image sensor 170, the bezel segments appears as bright “white” bands having a substantially even intensity over their lengths in image frames captured by the imaging assembly 1160.

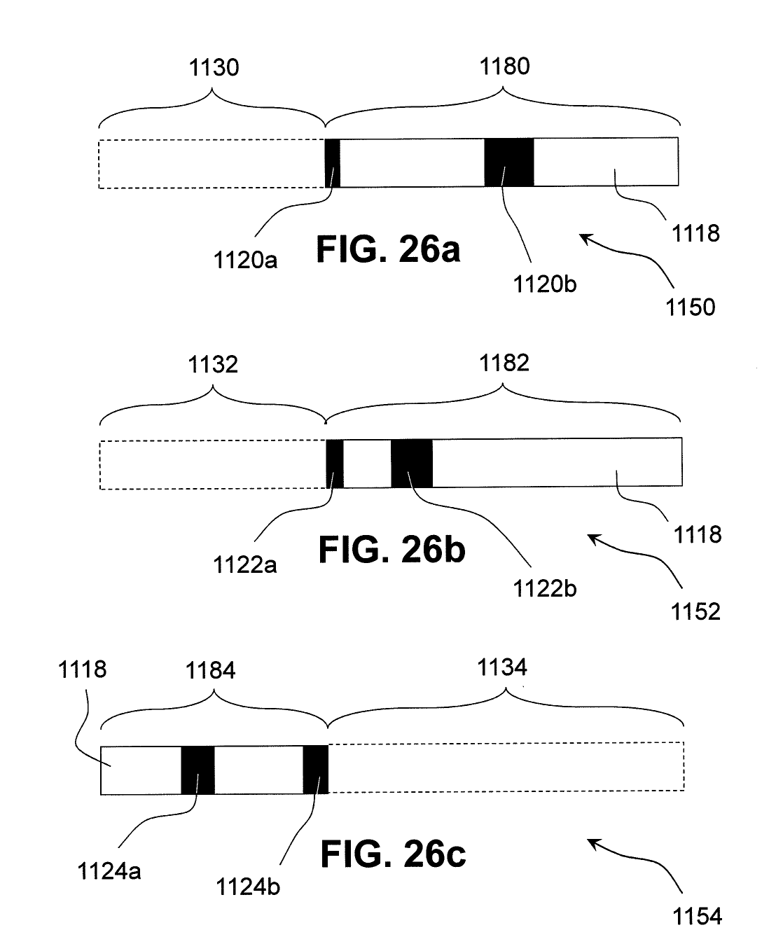

When a pointer is brought into proximity with the display surface 124, the pointer occludes infrared illumination, and as a result dark regions interrupting a bright band representing the pointer appear in image frames are captured by the image sensor 170. The interaction between the pointer A of FIGS. 25a through 25c and the illumination emitted by each of the light sources 1190 through 1194 are shown in FIGS. 26a through 26c, respectively. For example, FIG. 26a illustrates the interaction of pointer A with illumination emitted by light source 1190 and captured by a pixel subset of image sensor 170, yielding image frame 1150. As shown in the image frame 1150 of FIG. 26a, this interaction gives rise to two dark spots 1120a and 1120b interrupting the bright band 1118 of bezel segment 1144, as seen by image sensor 170. The dark spots 1120a and 1120b may be accounted for by considering a plurality of light paths that result from the interaction of pointer A with the infrared illumination emitted by light source 1190, as illustrated in FIG. 25a. Dark spot 1120a is caused by occlusion by pointer A of illumination emitted by light source 1190 after being reflected by bezel segment 1144, and where the occluded light is bounded by the edge of the captured image frame and light path 1190a. Dark spot 1120b is caused by occlusion by pointer A of illumination emitted by light source 1190, where the occluded light is bounded by light paths 1190b and 1190c. Image frame 1150 is composed from data captured by a pixel subset of image sensor 170 and indicated as region 1180 of FIG. 26a. The region outside of the pixel subset, namely region 1130, is not captured by the image sensor, and information within this region is therefore not communicated to DSP 178 for processing.

FIG. 26b illustrates the interaction of pointer A with illumination emitted by light source 1192, and captured by a pixel subset of image sensor 170, yielding image frame 1152. This interaction gives rise to two dark spots 1122a and 1122b interrupting the bright band 1118 of bezel segment 1144, as seen by image sensor 170. The dark spots 1122a and 1122b may be accounted for by considering a plurality of light paths that result from the interaction of pointer A with the infrared illumination emitted by light source 1192, as illustrated in FIG. 25b. Dark spot 1122a is caused by the occlusion by pointer A of illumination emitted by light source 1192 after said light reflecting off of bezel segment 1146, then again reflecting off bezel segment 1144, and where the occluded light is bounded by the edge of the captured image frame and light path 1192a. Dark spot 1122b is caused by occlusion of illumination emitted by light source 1192 by pointer A, and where the occluded light is bounded by light paths 1192b and 1192c. Image frame 1152 is composed of data captured by a pixel subset of image sensor 170 and indicated as region 1182 in FIG. 26b. The region outside of the pixel subset, namely area 1132, is not captured by the image sensor and information within this region is therefore not communicated to DSP 178 for processing.

FIG. 26c illustrates the interaction of pointer A with illumination emitted by light source 1194, and captured by a pixel subset of image sensor 170, producing image frame 1154. This interaction gives rise to two dark spots 1124a and 1124b interrupting the bright band 1118 of bezel segment 1140, as seen by image sensor 170. The dark spots 1124a and 1124b may be accounted for by considering a plurality of light paths that result from the interaction of pointer A with the infrared illumination emitted by light source 1194, as illustrated in FIG. 25c. Dark spot 1124a is caused by the occlusion by pointer A of illumination emitted by light source 1194 after said light reflecting off of bezel segment 1142, then again reflecting off bezel segment 1140, and where the occluded light is bounded by the edge of the captured image frame and light path 1194a. Dark spot 1124b is caused by occlusion by pointer A of illumination emitted by light source 1194 after the light reflects off bezel segment 1142, and where the occluded light is bounded by light paths 1194b and 1194c. Image frame 1154 is composed of data captured by a pixel subset of image sensor 170 and indicated as region 1184 in FIG. 26c. Information outside of this region is therefore not communicated to DSP 178 for processing.

Each image frame output by the image sensor 170 of imaging assembly 1160 is conveyed to the DSP 1178. When the DSP 1178 receives an image frame, the DSP 1178 processes the image frame to detect the existence of a pointer therein and if a pointer exists, generates pointer data that identifies the position of the pointer within the image frame. The DSP 1178 then conveys the pointer data to the master controller 126 via serial port 182 and communication lines 206.

When the master controller 126 receives pointer data from each of three successive image frames, 1150, 1152 and 1154, from imaging assembly 1160, the master controller calculates the position of the pointer in (x,y) coordinates relative to the display surface 124 using simple, well known triangulation techniques similar to that described in above. The calculated pointer position is then conveyed by the master controller 126 to the general purpose computing device 128. The general purpose computing device 128 in turn processes the received pointer position and updates the image output provided to the display controller 130, if required, so that the image presented on the display surface 124 can be updated to reflect the pointer activity. In this manner, pointer interaction with the display surface 124 can be recorded as writing or drawing or used to control execution of one or more application programs running on the general purpose computing device 128.

To reduce the amount of data to be processed, only the area of the image frames occupied by the bezel segments need be processed. A bezel finding procedure similar to that described in U.S. Patent Application Publication No. 2009/0277694 to Hansen et al. entitled “Interactive Input System and Bezel Therefor” filed on May 9, 2008 and assigned to SMART Technologies ULC of Calgary, Alberta, the content of which is incorporated herein by reference in its entirety, may be employed to locate the bezel segments in captured image frames. Of course, those of skill in the art will appreciate that other suitable techniques may be employed to locate the bezel segments in captured image frames.

Although in the embodiment described above, information from regions outside of pixel subsets is not captured by the image sensor, and is therefore not communicated to the DSP for processing, in other embodiments, information from regions outside of the pixel subsets may alternatively be captured by the image sensor and be communicated to the DSP, and be removed by the DSP before analysis of the captured image frame begins.

Although in embodiments described above the frame assembly is described as being attached to the display unit, in other embodiments, the frame assembly may alternatively be configured differently. For example, in one such embodiment, the frame assembly may alternatively be integral with the bezel. In another such embodiment, the assembly may comprise its own panel overlying the display surface. Here, the panel could be formed of a substantially transparent material so that the image presented on the display surface is clearly visible through the panel. The assemblies may alternatively be used with front or rear projection devices, and may surround a display surface on which the computer-generated image is projected. In still other embodiments, the assembly may alternatively be used separately from a display unit as an input device.

Although in embodiments described above, the mirror elements of the faceted multi-angle reflectors are described as being generally planar, in other embodiments the mirror elements may alternatively have convex or concave surfaces. In still other embodiments, the shape of the mirror elements may alternatively vary along the length of the bezel segment.

Although in embodiments described above the IR light sources comprise IR LEDs, in other embodiments other IR light sources may alternatively be used. In still other embodiments, the IR light sources may alternatively incorporate bezel illumination techniques as described in U.S. Patent Application Publication No. 2009/0278795 to Hansen et al., entitled “Interactive Input System and Illumination Assembly Therefor” filed on May 9, 2008 and assigned to SMART Technologies ULC of Calgary, Alberta, the content of which is incorporated herein by reference in its entirety.

Although in embodiments described above the assembly comprises IR light sources, in other embodiments, the assembly may alternatively comprise light sources that emit light at non-infrared wavelengths. However, as will be appreciated, light sources that emit non-visible light are desirable so as to avoid interference of illumination emitted by the light sources with visible images presented on the display surface 124.

Although in embodiments described above the image sensors are positioned adjacent corners and sides of the display surface and are configured to look generally across the display surface, in other embodiments, the imaging assemblies may alternatively be positioned elsewhere relative to the display surface.

Although in embodiments described above, the processing structures comprise a master controller and a general purpose computing device, in other embodiments, other processing structures may be used. For example, in one to embodiment, the master controller may alternatively be eliminated and its processing functions may be performed by the general purpose computing device. In another embodiment, the master controller may alternatively be configured to process the image frame data output by the image sensors both to detect the existence of a pointer in captured image frames and to triangulate the position of the pointer. Similarly, although in embodiments described above the imaging assemblies and master controller are described as comprising DSPs, in other embodiments, other processors such as microcontrollers, central processing units (CPUs), graphics processing units (GPUs), and/or cell-processors may alternatively be used.

Although in embodiments described above the side facets are coated with an absorbing paint to reduce their reflectivity, in other embodiments, the side facets may alternatively be textured to reduce their reflectivity.

Although in embodiments described above, bezel segments comprise two or more adjacently positioned plastic films in which faceted multi-angle reflectors and are formed, in other embodiments, the bezel segments may alternatively comprise a single plastic film in which parallel multi-angle reflectors are formed.

Although embodiments have been described, those of skill in the art will appreciate that other variations and modifications may be made without departing from the scope thereof as defined by the appended claims.

What is claimed is:

1. An interactive input system comprising:
at least one image sensor capturing image frames of a region of interest;
at least one light source emitting illumination into the region of interest;
a bezel at least partially surrounding the region of interest, the bezel comprising at least one multi-angle reflector reflecting the illumination emitted from to the light source towards the at least one image sensor; and
processing structure in communication with the at least one image sensor processing captured image frames for locating a pointer positioned in proximity with the region of interest.

2. An interactive input system according to claim 1 wherein the multi-angle reflector comprises at least one series of mirror elements extending along the bezel, the mirror elements being configured to reflect the illumination emitted from the at least one light source towards the at least one image sensor.

3. An interactive input system according to claim 1 wherein each mirror element is sized to be smaller than the pixel resolution of the at least one image sensor.

4. An interactive input system according to claim 3 wherein each mirror element presents a reflective surface that is angled to reflect the illumination emitted from the at least one light source towards the at least one image sensor.

5. An interactive input system according to claim 4 wherein each reflective surface is generally planar.

6. An interactive input system according to claim 4 wherein each reflective surface is generally convex.

7. An interactive input system according to claim 4 wherein each reflective surface is generally concave.

8. An interactive input system according to claim 4 wherein the configuration of the reflective surfaces varies over the length of the bezel.

9. An interactive input system according to claim 8 wherein each reflective surface has a configuration selected from the group consisting of: generally planar; generally convex; and generally concave.

10. An interactive input system according to claim 2 wherein the at least one light source creates at least two paths of occluded illumination in the presence of a pointer.

11. An interactive input system according to claim 1 wherein the at least one light source emits non-visible illumination.

12. An interactive input system according to claim 11 wherein the non-visible illumination is infrared illumination.

13. An interactive input system according to claim 12 wherein the at least one light source comprises one or more infrared light emitting diodes.

14. An interactive input system according to claim 4 wherein the bezel comprises a backing and a film on the backing, the film being configured to form the multi-angle reflector.

15. An interactive input system according to claim 14 wherein the film is machined and engraved to form the multi-angle reflector.

16. An interactive input system according to claim 1 where the processing structure processing captured image frames further calculates an approximate size and shape of the pointer within the region of interest.

17. An interactive input system according to claim 16 wherein the multi-angle reflector comprises at least one series of mirror elements extending along the bezel, the mirror elements being configured to reflect illumination emitted from the at least one light source towards the at least one image sensor.

18. An interactive input system according to claim 17 wherein each mirror element is sized smaller than the pixel resolution of the at least one image sensor.

19. An interactive input system according to claim 18 wherein each mirror element presents a reflective surface that is angled to reflect illumination emitted from the at least one light source towards the at least one image sensor.

20. An interactive input system according to claim 1, further comprising at least two image sensors, the image sensors looking into the region of interest from different vantages and having overlapping fields of view, each bezel segment seen by an image sensor comprising a multi-angle reflector to reflect illumination emitted from the at least one light source towards that image sensor.

21. An interactive input system according to claim 20 wherein each bezel segment seen by more than one image sensor comprises a multi-angle reflector for each image sensor, each at least one series of mirror elements extending along the bezel.

22. An interactive input system according to claim 20 further comprising processing structure communicating with the at least two image sensors and processing image frames output thereby to determine an approximate size of a pointer within the region of interest.

23. An interactive input system according to claim 20 wherein the region of interest is generally rectangular and wherein the bezel comprises a plurality of bezel segments, each bezel segment extending along a different side of the region of interest.

24. An interactive input system according to claim 23 wherein the bezel extends along three sides of the region of interest.

25. An interactive input system according to claim 24, wherein one of the bezel segments is visible to both image sensors and each of the other bezel segments is visible to only one image sensor.

26. An interactive input system according to claim 25 further comprising processing structure communicating with the at least one image sensor and processing captured image frames to determine an approximate size of a pointer within the region of interest.

27. An interactive input system according to claim 1 wherein the multi-angle reflector comprises at least one series of mirror elements extending along a bezel not within view of the at least one image sensor, the mirror elements being configured to reflect illumination emitted from the at least one light source towards another multi-angle reflector extending along an opposite bezel from which the illumination is reflected towards the at least one image sensor.

28. An interactive input system comprising:
at least one image sensor capturing image frames of a region of interest;
a plurality of light sources emitting illumination into the region of interest;
a bezel at least partially surrounding the region of interest, the bezel comprising a multi-angle reflector to reflect illumination emitted from the plurality of light sources towards the image sensor; and
processing structure in communication with the image sensor processing captured image frames for locating a pointer positioned in proximity with the region of interest.

29. An interactive input system comprising:
a plurality of image sensors each capturing image frames of a region of interest;
a light source emitting illumination into the region of interest;
a bezel at least partially surrounding the region of interest, the bezel comprising a multi-angle reflector to reflect illumination emitted from the light source towards the plurality of image sensors; and
processing structure in communication with the image sensors processing captured image frames for locating a pointer positioned in proximity with the region of interest.

30. An interactive input system comprising:
a bezel at least partially surrounding a region of interest, the bezel having a plurality of films thereon with adjacent films having different reflective structures;
at least one image sensor looking into the region of interest and seeing the at least one bezel so that acquired image frames comprise regions corresponding to the films; and
processing structure processing pixels of a plurality of the regions to detect the existence of a pointer in the region of interest.

31. An interactive input system according to claim 30 wherein the processing structure processes the pixels to detect discontinuities in the regions caused by the existence of the pointer.

32. An interactive input system according to claim 31 wherein the films are generally horizontal.

33. An interactive input system according to claim 32 wherein the films comprise at least one film that reflects illumination from a first source of illumination towards at least one of the image sensors, and least another film that reflects illumination from a second source of illumination towards the image sensor.

34. An interactive input system comprising:
at least two image sensors capturing images of a region of interest;
at least two light sources to provide illumination into the region of interest;
a controller timing the frame rates of the image sensors with distinct switching patterns assigned to the light sources; and
processing structure processing the separated image frames to determine the location of a pointer within the region of interest.

35. An interactive input system according to claim 34 wherein each light source is switched on and off according to a distinct switching pattern.

36. An interactive input system according to claim 35 wherein the distinct switching patterns are substantially sequential.

37. A method of generating image frames in an interactive input system comprising at least one image sensor capturing images of a region of interest and multiple light sources providing illumination into the region of interest, the method comprising:
turning each light source on and off according to a distinct sequence;
synchronizing the frame rate of the image sensor with the distinct sequence; and
processing the captured image frames to yield image frames based on contributions from different light sources.
